(19) United States
(12) Patent Application Publication
(10) Pub. No.: US 2025/0078662 A1
(43) Pub. Date: Mar. 6, 2025

(54) IDENTIFICATION AND FORMATION OF VEHICULAR PLATOON

(71) Applicant: QUALCOMM Incorporated, San Diego, CA (US)

(72) Inventors: Mohammad Raashid ANSARI, Saugus, MA (US); Mohit NARULA, San Diego, CA (US); Jean-Philippe MONTEUUIS, Northborough, MA (US); Jonathan PETIT, Wenham, MA (US)

(21) Appl. No.: 18/462,327

(22) Filed: Sep. 6, 2023

(51) Int. Cl. G08G 1/00; G05D 1/02

(52) U.S. Cl. CPC G08G 1/22; G08G 1/20

(57) ABSTRACT

Apparatus, methods, and computer program products for platoon formation are provided. An example method may include identifying a set of non-malicious vehicles based on at least one of data associated with the set of non-malicious vehicles or communication from a second vehicle or a RSU. The example method may further include transmitting a request message to the set of non-malicious vehicles. The example method may further include receiving an acceptance message from at least one vehicle of the set of non-malicious vehicles. The example method may further include configuring a platoon with the at least one vehicle of the set of non-malicious vehicles.

### TECHNICAL FIELD

The present disclosure relates generally to communication systems, and more particularly, to communications facilitating platoon formation.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at a first vehicle are provided. The apparatus may include at least one memory and at least one processor coupled to the at least one memory. Based at least in part on information stored in the at least one memory, the at least one processor, individually or in any combination, is configured to identify a set of non-malicious vehicles based on at least one of data associated with the set of non-malicious vehicles or communication from a second vehicle or a road side unit (RSU). Based at least in part on information stored in the at least one memory, the at least one processor, individually or in any combination, is configured to transmit a request message to the set of non-malicious vehicles. Based at least in part on information stored in the at least one memory, the at least one processor, individually or in any combination, is configured to receive an acceptance message from at least one vehicle of the set of non-malicious vehicles. Based at least in part on information stored in the at least one memory, the at least one processor, individually or in any combination, is configured to configure a platoon with the at least one vehicle of the set of non-malicious vehicles.

To the accomplishment of the foregoing and related ends, the one or more aspects include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2 illustrates example aspects of a sidelink slot structure.

FIG. 3 is a diagram illustrating an example of a first device and a second device involved in wireless communication based, e.g., on sidelink.

FIG. 4 illustrates an example of sidelink communication between devices.

FIG. 5 is a diagram illustrating an example of user equipment (UE) positioning based on reference signal measurements.

FIG. 6 is a diagram illustrating communications between vehicles for platoon formation.

FIG. 7 is a diagram illustrating communications between vehicles for platoon formation.

FIG. 8 is a diagram illustrating movement of vehicles related to operations associated with a platoon.

FIG. 9 is a diagram illustrating communications between RSUs and vehicles for platoon formation.

FIG. 10 is a diagram illustrating movement of vehicles related to operations associated with a platoon.

FIG. 11 is a diagram illustrating communications between vehicles related to disengagement of platoon and join of platoon.

FIG. 12 is a flowchart of a method of platoon formation.

FIG. 13 is a flowchart of a method of platoon formation.

FIG. 14 is a diagram illustrating an example of a hardware implementation for an example apparatus and/or network entity.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

Identifying and forming vehicular platoons with non-malicious vehicles may be important for proper functioning of the platoon. Verifying platoon participants after forming a platoon may also be important in case bad actors enters a platoon. In some systems, platoon formation may be coordinated by a central entity. However, such an implementation would make the central entity to be a single point of failure where any error/failure by the central entity may affect the operations of all vehicles. Aspects provided herein may facilitate distributed platoon formation where the vehicles themselves may also be contributing in platoon formation, increasing reliability of platoons and decreasing the risk of having bad actors in the platoon.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUS), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer. While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

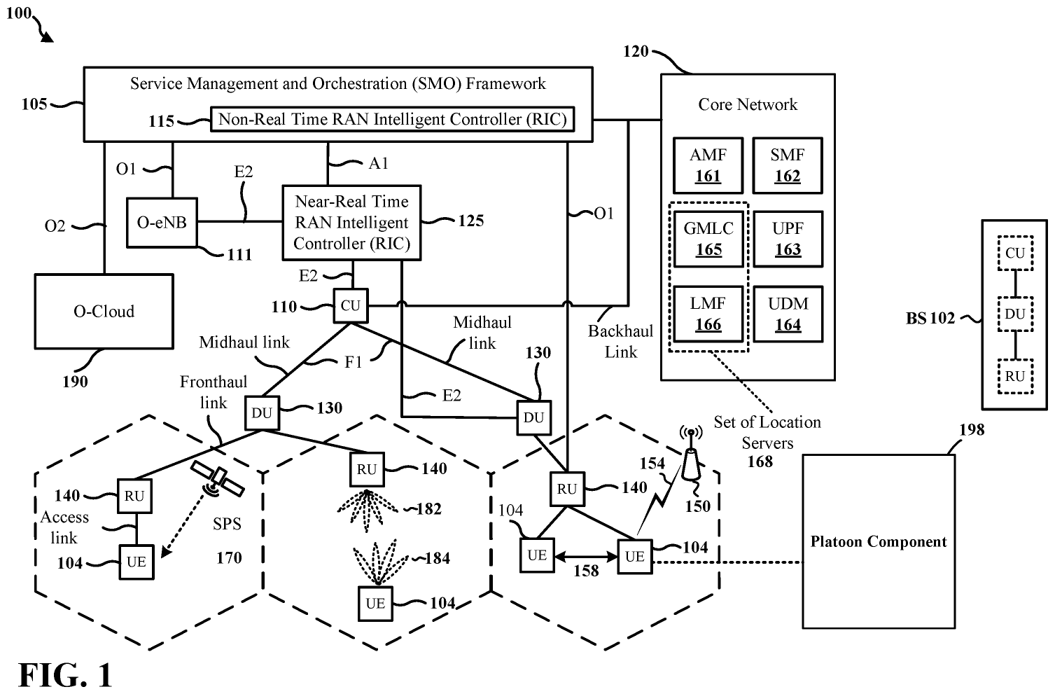

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140. Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHZ (e.g., 5, 10, 15, 20, 100, 400, etc. MHz) bandwidth per carrier allocated in a carrier aggregation of up to a total of Yx MHZ (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHZ-52.6 GHZ). Although a portion of FR1 is greater than 6 GHZ, FR1 is often referred to (interchangeably) as a “sub-6 GHz” band in various documents and articles. A similar nomenclature issue sometimes occurs with regard to FR2. which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, cNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

A link between a UE 104 and a base station 102 may be established as an access link, e.g., using a Uu interface. Other communication may be exchanged between wireless devices based on sidelink. For example, some UEs 104 may communicate with each other directly using a device-to-device (D2D) communication link 158. In some examples, the D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

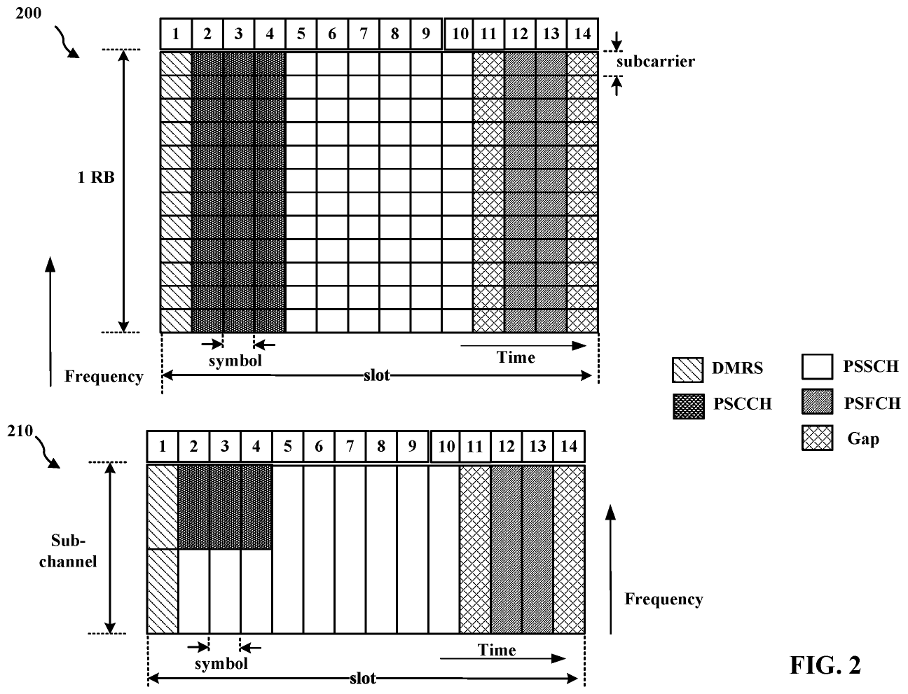

Some examples of sidelink communication may include vehicle-based communication devices that can communicate from vehicle-to-vehicle (V2V), vehicle-to-infrastructure (V2I) (e.g., from the vehicle-based communication device to road infrastructure nodes such as a Road Side Unit (RSU)), vehicle-to-network (V2N) (e.g., from the vehicle-based communication device to one or more network nodes, such as a base station), vehicle-to-pedestrian (V2P), cellular vehicle-to-everything (C-V2X), and/or a combination thereof and/or with other devices, which can be collectively referred to as vehicle-to-anything (V2X) communications. Sidelink communication may be based on V2X or other D2D communication, such as Proximity Services (ProSe), etc. In addition to UEs, sidelink communication may also be transmitted and received by other transmitting and receiving devices, such as Road Side Unit (RSU), etc. Sidelink communication may be exchanged using a PC5 interface, such as described in connection with the example in FIG. 2. Although the following description, including the example slot structure of FIG. 2, may provide examples for sidelink communication in connection with 5G NR, the concepts described herein may be applicable to other similar areas, such as LTE, LTE-A, CDMA, GSM, and other wireless technologies.

Referring again to FIG. 1, in some aspects, the UE 104 may include a platoon component 198. In some aspects, the platoon component 198 may be configured to identify a set of non-malicious vehicles based on at least one of data associated with the set of non-malicious vehicles or communication from a second vehicle or a RSU. In some aspects, the platoon component 198 may be further configured to transmit a request message to the set of non-malicious vehicles. In some aspects, the platoon component 198 may be further configured to receive an acceptance message from at least one vehicle of the set of non-malicious vehicles. In some aspects, the platoon component 198 may be further configured to configure a platoon with the at least one vehicle of the set of non-malicious vehicles.

Although the following description may be focused on 5G NR, the concepts described herein may be applicable to other similar areas, such as LTE, LTE-A, CDMA, GSM, and other wireless technologies.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

FIG. 2 includes diagrams 200 and 210 illustrating example aspects of slot structures that may be used for sidelink communication (e.g., between UEs 104, RSU, etc.). The slot structure may be within a 5G/NR frame structure in some examples. In other examples, the slot structure may be within an LTE frame structure. Although the following description may be focused on 5G NR, the concepts described herein may be applicable to other similar areas, such as LTE, LTE-A, CDMA, GSM, and other wireless technologies. The example slot structure in FIG. 2 is merely one example, and other sidelink communication may have a different frame structure and/or different channels for sidelink communication. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. Diagram 200 illustrates a single resource block of a single slot transmission, e.g., which may correspond to a 0.5 ms transmission time interval (TTI). A physical sidelink control channel may be configured to occupy multiple physical resource blocks (PRBs), e.g., 10, 12, 15, 20, or 25 PRBs. The PSCCH may be limited to a single sub-channel. A PSCCH duration may be configured to be 2 symbols or 3 symbols, for example. A sub-channel may include 10, 15, 20, 25, 50, 75, or 100 PRBs, for example. The resources for a sidelink transmission may be selected from a resource pool including one or more subchannels. As a non-limiting example, the resource pool may include between 1-27 subchannels. A PSCCH size may be established for a resource pool, e.g., as between 10-100% of one subchannel for a duration of 2 symbols or 3 symbols. The diagram 210 in FIG. 2 illustrates an example in which the PSCCH occupies about 50% of a subchannel, as one example to illustrate the concept of PSCCH occupying a portion of a subchannel. The physical sidelink shared channel (PSSCH) occupies at least one subchannel. The PSCCH may include a first portion of sidelink control information (SCI), and the PSSCH may include a second portion of SCI in some examples.

A resource grid may be used to represent the frame structure. Each time slot may include a resource block (RB) (also referred to as physical RBs (PRBs)) that extends 12 consecutive subcarriers. The resource grid is divided into multiple resource elements (REs). The number of bits carried by each RE depends on the modulation scheme. As illustrated in FIG. 2, some of the REs may include control information in PSCCH and some REs may include demodulation RS (DMRS). At least one symbol may be used for feedback. FIG. 2 illustrates examples with two symbols for a physical sidelink feedback channel (PSFCH) with adjacent gap symbols. A symbol prior to and/or after the feedback may be used for turnaround between reception of data and transmission of the feedback. The gap enables a device to switch from operating as a transmitting device to prepare to operate as a receiving device, e.g., in the following slot. Data may be transmitted in the remaining REs, as illustrated. The data may include the data message described herein. The position of any of the data, DMRS. SCI, feedback, gap symbols, and/or LBT symbols may be different than the example illustrated in FIG. 2. Multiple slots may be aggregated together in some aspects.

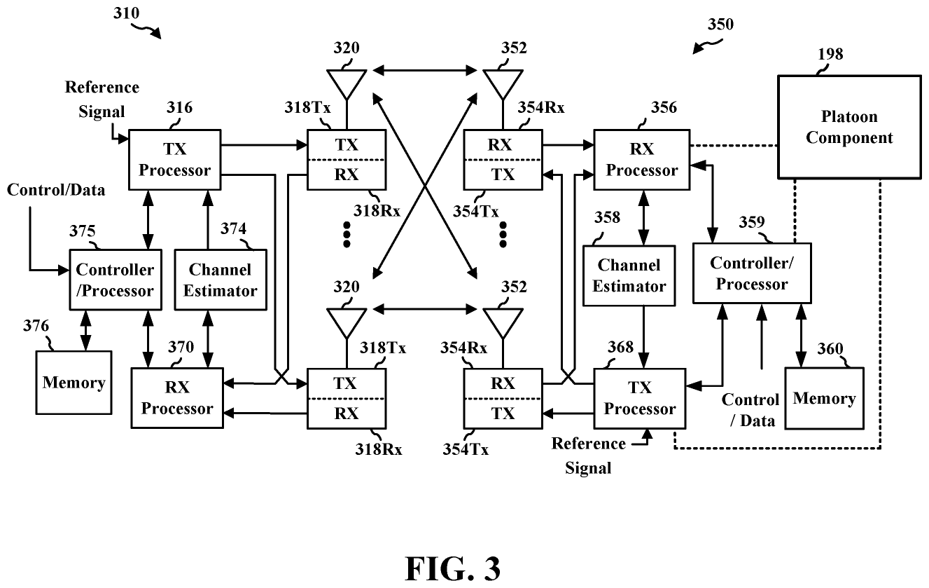

FIG. 3 is a block diagram of a first wireless communication device 310 in communication with a second wireless communication device 350 based on sidelink. In some examples, the devices 310 and 350 may communicate based on V2X or other D2D communication. The communication may be based on sidelink using a PC5 interface. The devices 310 and the 350 may include a UE, an RSU, a base station, etc. Packets may be provided to a controller/processor 375 that implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the device 350. Each spatial stream may then be provided to a different antenna 320 via a separate transmitter 318Tx. Each transmitter 318Tx may modulate an RF carrier with a respective spatial stream for transmission.

At the device 350, each receiver 354Rx receives a signal through its respective antenna 352. Each receiver recovers information modulated onto an RF carrier and provides the information to the receive (Rx) processor 356. The TX processor 368 and the RX processor 356 implement layer 1 functionality associated with various signal processing functions. The RX processor 356 may perform spatial processing on the information to recover any spatial streams destined for the device 350. If multiple spatial streams are destined for the device 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by device 310. These soft decisions may be based on channel estimates computed by the channel estimator 358. The soft decisions are then decoded and deinterleaved to recover the data and control signals that were originally transmitted by device 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. The controller/processor 359 may provide demultiplexing between transport and logical channels, packet reassembly, deciphering, header decompression, and control signal processing. The controller/processor 359 is also responsible for error detection using an ACK and/or NACK protocol to support HARQ operations.

Similar to the functionality described in connection with the transmission by device 310, the controller/processor 359 may provide RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ. priority handling, and logical channel prioritization.

Channel estimates derived by a channel estimator 358 from a reference signal or feedback transmitted by device 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The transmission is processed at the device 310 in a manner similar to that described in connection with the receiver function at the device 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. The controller/processor 375 provides demultiplexing between transport and logical channels, packet reassembly, deciphering, header decompression, control signal processing. The controller/processor 375 is also responsible for error detection using an ACK and/or NACK protocol to support HARQ operations.

At least one of the TX processor 368, the RX processor 356, and the controller/processor 359 may be configured to perform aspects in connection with platoon component 198 of FIG. 1.

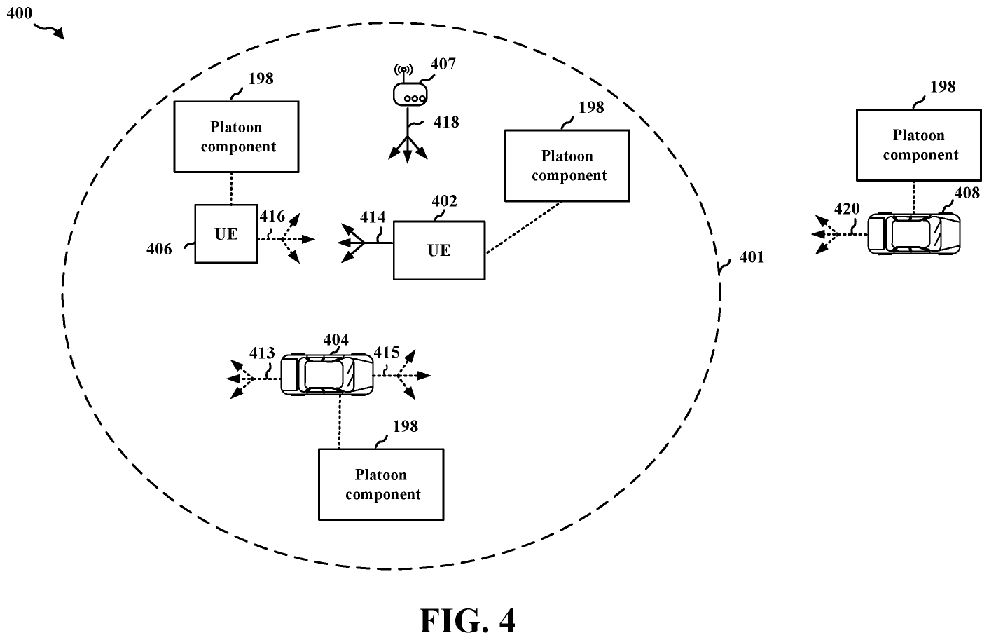

FIG. 4 illustrates an example 400 of sidelink communication between devices. The communication may be based on a slot structure including aspects described in connection with FIG. 2. For example, the UE 402 may transmit a sidelink transmission 414, e.g., including a control channel (e.g., PSCCH) and/or a corresponding data channel (e.g., PSSCH), that may be received by UEs 404, 406, 408. A control channel may include information (e.g., sidelink control information (SCI)) for decoding the data channel including reservation information, such as information about time and/or frequency resources that are reserved for the data channel transmission. For example, the SCI may indicate a number of TTIs, as well as the RBs that will be occupied by the data transmission. The SCI may also be used by receiving devices to avoid interference by refraining from transmitting on the reserved resources. The UEs 402, 404, 406, 408 may each be capable of sidelink transmission in addition to sidelink reception. Thus, UEs 404, 406, 408 are illustrated as transmitting sidelink transmissions 413, 415, 416, 420. The sidelink transmissions 413, 414, 415, 416, 420 may be unicast, broadcast or multicast to nearby devices. For example, UE 404 may transmit transmissions 413, 415 intended for receipt by other UEs within a range 401 of UE 404, and UE 406 may transmit transmission 416. Additionally/alternatively, RSU 407 may receive communication from and/or transmit transmission 418 to UEs 402, 404, 406, 408. One or more of the UEs 402. 404, 406, 408 or the RSU 407 may include a platoon component 198 as described in connection with FIG. 1.

Sidelink communication may be based on different types or modes of resource allocation mechanisms. In a first resource allocation mode (which may be referred to herein as “Mode 1”), centralized resource allocation may be provided by a network entity. For example, a base station 102 may determine resources for sidelink communication and may allocate resources to different UEs 104 to use for sidelink transmissions. In this first mode, a UE receives the allocation of sidelink resources from the base station 102. In a second resource allocation mode (which may be referred to herein as “Mode 2”), distributed resource allocation may be provided. In Mode 2, each UE may autonomously determine resources to use for sidelink transmission. In order to coordinate the selection of sidelink resources by individual UEs, each UE may use a sensing technique to monitor for resource reservations by other sidelink UEs and may select resources for sidelink transmissions from unreserved resources. Devices communicating based on sidelink, may determine one or more radio resources in the time and frequency domain that are used by other devices in order to select transmission resources that avoid collisions with other devices. The sidelink transmission and/or the resource reservation may be periodic or aperiodic, where a UE may reserve resources for transmission in a current slot and up to two future slots (discussed below).

Thus, in the second mode (e.g., Mode 2), individual UEs may autonomously select resources for sidelink transmission, e.g., without a central entity such as a base station indicating the resources for the device. A first UE may reserve the selected resources in order to inform other UEs about the resources that the first UE intends to use for sidelink transmission(s).

In some examples, the resource selection for sidelink communication may be based on a sensing-based mechanism. For instance, before selecting a resource for a data transmission, a UE may first determine whether resources have been reserved by other UEs.

For example, as part of a sensing mechanism for resource allocation mode 2, the UE may determine (e.g., sense) whether the selected sidelink resource has been reserved by other UE(s) before selecting a sidelink resource for a data transmission. If the UE determines that the sidelink resource has not been reserved by other UEs, the UE may use the selected sidelink resource for transmitting the data, e.g., in a PSSCH transmission. The UE may estimate or determine which radio resources (e.g., sidelink resources) may be in-use and/or reserved by others by detecting and decoding sidelink control information (SCI) transmitted by other UEs. The UE may use a sensing-based resource selection algorithm to estimate or determine which radio resources are in-use and/or reserved by others. The UE may receive SCI from another UE that includes reservation information based on a resource reservation field included in the SCI. The UE may continuously monitor for (e.g., sense) and decode SCI from peer UEs. The SCI may include reservation information, e.g., indicating slots and RBs that a particular UE has selected for a future transmission. The UE may exclude resources that are used and/or reserved by other UEs from a set of candidate resources for sidelink transmission by the UE, and the UE may select/reserve resources for a sidelink transmission from the resources that are unused and therefore form the set of candidate resources. The UE may continuously perform sensing for SCI with resource reservations in order to maintain a set of candidate resources from which the UE may select one or more resources for a sidelink transmission. Once the UE selects a candidate resource, the UE may transmit SCI indicating its own reservation of the resource for a sidelink transmission. The number of resources (e.g., sub-channels per subframe) reserved by the UE may depend on the size of data to be transmitted by the UE. Although the example is described for a UE receiving reservations from another UE, the reservations may also be received from an RSU or other device communicating based on sidelink.

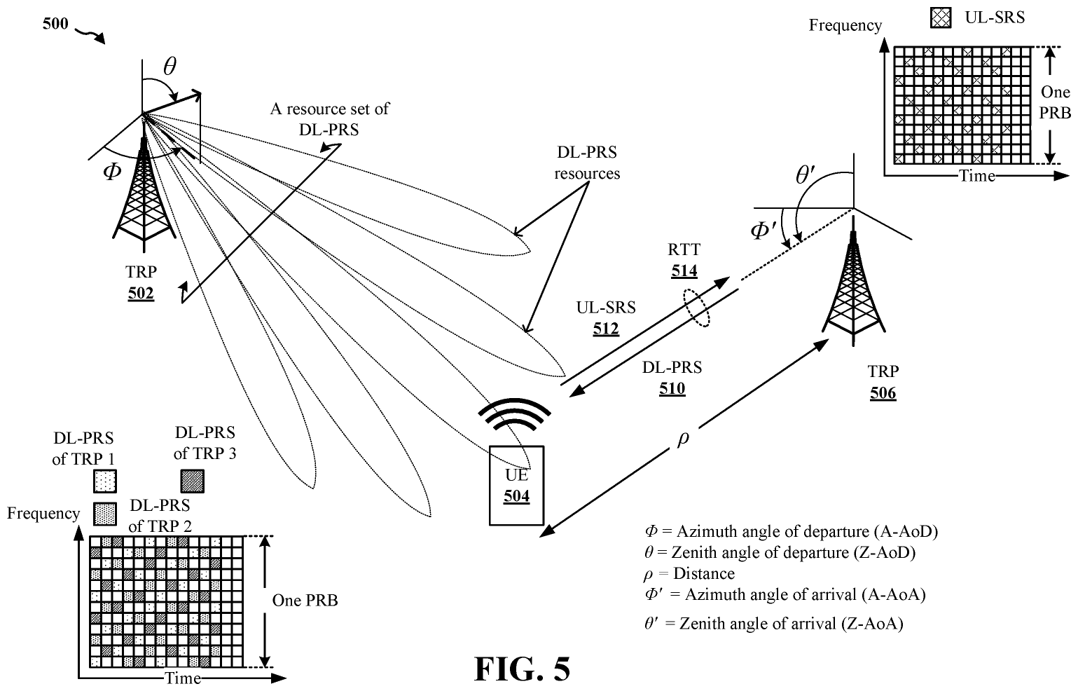

FIG. 5 is a diagram 500 illustrating an example of a UE positioning based on reference signal measurements. The UE 504 may transmit UL-SRS 512 at time T_{SRS_TX} and receive DL positioning reference signals (PRS) (DL-PRS) 510 at time T_{PRS_RX}. The TRP 506 may receive the UL-SRS 512 at time T_{SRS_RX} and transmit the DL-PRS 510 at time T_{PRS_TX}. The UE 504 may receive the DL-PRS 510 before transmitting the UL-SRS 512, or may transmit the UL-SRS 512 before receiving the DL-PRS 510. In both cases, a positioning server (e.g., location server(s) 168) or the UE 504 may determine the RTT 514 based on |T_{SRS_RX}−T_{PRS_TX}|−|T_{SRS_TX}−T_{PRS_RX}∥. Accordingly, multi-RTT positioning may make use of the UE Rx-Tx time difference measurements (i.e., |T_{SRS_TX}−T_{PRS_RX}|) and DL-PRS reference signal received power (RSRP) (DL-PRS-RSRP) of downlink signals received from multiple TRPs 502, 506 and measured by the UE 504, and the measured TRP Rx-Tx time difference measurements (i.e., |T_{SRS_RX}−T_{PRS_TX}|) and UL-SRS-RSRP at multiple TRPs 502. 506 of uplink signals transmitted from UE 504. The UE 504 measures the UE Rx-Tx time difference measurements (and optionally DL-PRS-RSRP of the received signals) using assistance data received from the positioning server, and the TRPs 502, 506 measure the gNB Rx-Tx time difference measurements (and optionally UL-SRS-RSRP of the received signals) using assistance data received from the positioning server. The measurements may be used at the positioning server or the UE 504 to determine the RTT, which is used to estimate the location of the UE 504. Other methods are possible for determining the RTT, such as for example using DL-TDOA and/or UL-TDOA measurements.

DL-AoD positioning may make use of the measured DL-PRS-RSRP of downlink signals received from multiple TRPs 502, 506 at the UE 504. The UE 504 measures the DL-PRS-RSRP of the received signals using assistance data received from the positioning server, and the resulting measurements are used along with the azimuth angle of departure (A-AoD), the zenith angle of departure (Z-AoD), and other configuration information to locate the UE 504 in relation to the neighboring TRPs 502,506.

DL-TDOA positioning may make use of the DL reference signal time difference (RSTD) (and optionally DL-PRS-RSRP) of downlink signals received from multiple TRPs 502, 506 at the UE 504. The UE 504 measures the DL RSTD (and optionally DL-PRS-RSRP) of the received signals using assistance data received from the positioning server, and the resulting measurements are used along with other configuration information to locate the UE 504 in relation to the neighboring TRPs 502,506.

UL-TDOA positioning may make use of the UL relative time of arrival (RTOA) (and optionally UL-SRS-RSRP) at multiple TRPs 502, 506 of uplink signals transmitted from UE 504. The TRPs 502, 506 measure the UL-RTOA (and optionally UL-SRS-RSRP) of the received signals using assistance data received from the positioning server, and the resulting measurements are used along with other configuration information to estimate the location of the UE 504.

UL-AoA positioning may make use of the measured azimuth angle of arrival (A-AoA) and zenith angle of arrival (Z-AoA) at multiple TRPs 502, 506 of uplink signals transmitted from the UE 504. The TRPs 502, 506 measure the A-AoA and the Z-AoA of the received signals using assistance data received from the positioning server, and the resulting measurements are used along with other configuration information to estimate the location of the UE 504.

Additional positioning methods may be used for estimating the location of the UE 504, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

As used herein, the term “malicious vehicle” may refer to a vehicle that is determined to be ineligible for joining a platoon of several vehicles. As used herein, the term “non-malicious vehicle” may refer to a vehicle that is determined to be eligible for joining a platoon of several vehicles. Determining whether a vehicle is non-malicious or malicious may be based on the kinematics data associated with the vehicle and communication associated with the vehicle. As used herein, the term “kinematics data” may refer to speed, acceleration, heading direction (which may also be referred to as “direction”), or other data associated with a vehicle. Kinematics data may also include a set of global navigation satellite system (GNSS) coordinates associated with the vehicle, a vehicle ID associated with the vehicle, a destination address associated with the vehicle, a fuel or battery status associated with the vehicle, or a trust level (e.g., trust information) associated with the vehicle. Kinematics data may be determined based on camera, radio detection and ranging (radar) sensor, light detection and ranging (Lidar) sensor, other types of vehicle to everything (V2X) sensor, a collective perception service, communications associated with the vehicle that may include speed, acceleration, direction, or other motion data such as basic safety messages, maneuver sharing and coordination message (MSCM) messages, other types of V2X messages, or the like. Determining whether a vehicle is non-malicious or malicious may also be based on trust information transmitted from other devices, such as other vehicles, RSUs, or the like. The term “trust information” may refer to information transmitted regarding whether a vehicle may be malicious or non-malicious, confidence level associated with whether a vehicle may be malicious or non-malicious, or other metrics regarding whether a vehicle may be malicious. For example, trust information may be exchanged within a platoon to determine (e.g., vote on) whether another vehicle outside the platoon is eligible to join the platoon or not. As used herein, the term “platoon” may refer to a group of more than one vehicles that may engage in close cooperative formations based on communications within the platoon. Each vehicle in a platoon may adapt its acceleration and speed with the help of a cooperative adaptive cruise controller (CACC) based on information received from other platoon members. A vehicle responsible for managing the CACC (and may be where the CACC is located at) may be referred to as the “leader” of the platoon or a “platoon leader.” A platoon may be formed on one or more lanes on the road, the one or more lanes in which the platoon is formed on may be referred to as “platoon formation lane.” Within a platoon, the vehicles may move based on an average speed associated with the platoon and may maintain an inter-vehicle distance associated with the platoon while moving. Each vehicle in the platoon may be assigned with a corresponding position within the platoon. A platoon may be configured to expire after a period of time or after a distance (e.g., after travelling for the distance). In some aspects, a vehicle within the platoon may depart from the platoon. In some aspects, a vehicle outside the platoon may request to join the platoon or may be identified as a potential candidate for joining the platoon and a platoon leader may transmit a request to join the platoon accordingly. In some aspects, the platoon leader may be determined via a voting process and may be determined based on longest distance, slowest speed, source and destination, same manufacturer, or the like. The positions of each vehicle within the platoon may be determined based on fuel efficiency, air-drag reduction, visibility, or the like. If a platoon leader departs from the platoon, the platoon leader may be transferred to be another vehicle (e.g., based on a voting process) and a communication key may be updated (e.g., by the leader).

To maintain privacy and security of data and physical vehicles (e.g., which may have passengers), aspects provided herein may facilitate ensuring no bad actors enter a platoon during identification and formation.

In some aspects, vehicles within the platoon may identify (e.g., periodically or aperiodically) malicious behavior associated with other vehicles within the platoon based on kinematics data. If malicious behavior is identified, one or more other vehicles in the platoon may communicate to determine whether to remove the vehicle detected with malicious behavior (e.g., such as via a voting process). In some aspects. if malicious behavior is identified, one or more other vehicles in the platoon may communicate with another entity, such as a RSU or a network entity, to determine whether to remove the vehicle detected with malicious behavior. In some aspects, a vehicle may also be removed from the platoon based on a request to depart from the vehicle.

To facilitate secure communications within a platoon, the members within the platoon may use a communication key to cipher communications within the platoon. As used herein, the term “communication key” may refer to a key for ciphering communications within the platoon that may be associated with the particular platoon. Upon establishment of the platoon, a communication key for the platoon may be generated and the communication key may be updated upon change of platoon member (e.g., a vehicle joining the platoon or a vehicle leaving the platoon). As used herein, the term “cryptographic certificate” may refer to a data used to prove the validity of a communication key and may be associated with a particular vehicle.

Vehicle platooning may enable vehicles to dynamically organize themselves in a group which travels together. Each vehicle in a platoon receives specific instructions from a vehicle leading the platoon (e.g., the platoon leader). To facilitate platoon, each of the vehicles may support V2X application and a specified rate of transmission, a payload size, a reliability percentage, a data rate, a communication range, an automation degree, or the like. Vehicles in a platoon can travel at closer inter-vehicle distance, which improves road and fuel efficiency. When vehicles are arranged in a platoon, the leader may transmit periodic or aperiodic instructions or messages to other vehicles guiding them with information to safely maintain and navigate in a platoon. A platoon may be formed using two methods, central or distributed. For central formation, vehicles may receive commands from a command center like a traffic control center or a fleet management service to form a platoon. For distributed formation, vehicles may communicate locally using some form of communication system to form the platoon.

Central formation of platoon based on a particular vehicle manufacturer may suffer from using a same proprietary communication devices and protocols, which may limit the formation of platoon. A traffic center (e.g., government controlled) based central formation of platoon may coordinate vehicles from different manufacturers.

Identifying and forming vehicular platoons with non-malicious vehicles may be important for proper functioning of the platoon. Verifying platoon participants after forming a platoon may also be important in case bad actors enters a platoon. In some systems, platoon formation may be coordinated by a central entity. However, such an implementation would make the central entity to be a single point of failure where any error/failure by the central entity may affect the operations of all vehicles. Aspects provided herein may facilitate distributed platoon formation where the vehicles themselves may also be contributing in platoon formation, increasing reliability of platoons and decreasing the risk of having bad actors in the platoon. There may be a central entity for monitoring the platoon.

In some aspects, distributed and secure identification of prospective platoon participants may be performed by vehicles or RSUs based on verification of kinematics data associated with the prospective platoon participants. The RSU may also engage in RSU-based platoon identification and formation based on kinematics data. In some aspects, a RSU may hand over platoon formation and management control to another RSU such that the closest RSU to the platoon may manage, control, monitor, or otherwise assist the platoon. In some aspects platoon formation may be based on MSCM and may be associated with periodic misbehavior detection.

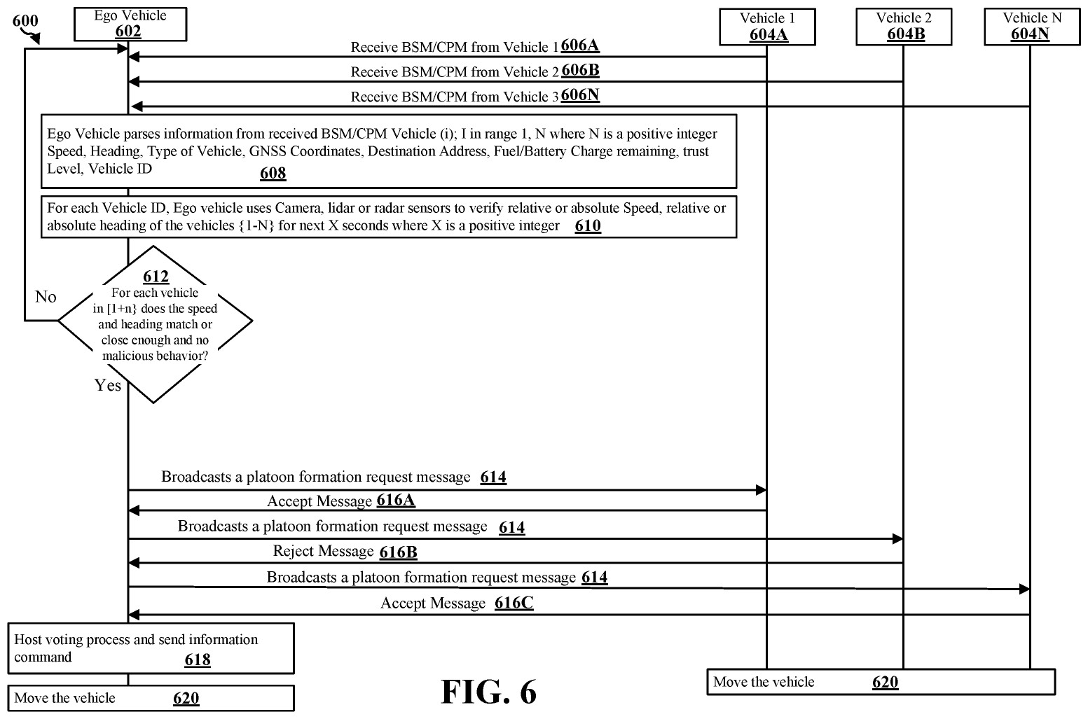

FIG. 6 is a diagram 600 illustrating communications between vehicles for platoon formation. As illustrated in FIG. 6, an ego vehicle 602 (e.g., which may be a vehicle to manage formation of a platoon) may identify one or more vehicles including a vehicle 604A, a vehicle 604B, and a vehicle 604N to be non-malicious. The vehicle 602 may be on the road and may passively monitor surrounding vehicles and tracks their kinematics for a number of seconds using V2X data it receives from basic safety messages and collective perception service. The parameters may include speed, heading, type of vehicle, GNSS coordinates, destination address, fuel or battery status, trust level, vehicle ID, or other kinematics data.

To identify the one or more vehicles including the vehicle 604A, the vehicle 604B, and the vehicle 604N to be non-malicious, the ego vehicle 602 may receive kinematics data associated with the vehicle 604A, the vehicle 604B, and the vehicle 604N. For example, the ego vehicle 602 may receive kinematics data associated with the vehicle 604A, the vehicle 604B, and the vehicle 604N based on a basic safety message (BSM) or a collective perception message (CPM) associated with the vehicle 604A, the vehicle 604B, and the vehicle 604N, such as a BSM/CPM 606A from the vehicle 604A, a BSM/CPM 606B from the vehicle 604B, and a BSM/CPM 606N from the vehicle 604N. In some aspects, upon receiving the BSM/CPM 606A from the vehicle 604A, the BSM/CPM 606B from the vehicle 604B, and the BSM/CPM 606N from the vehicle 604N, at 608, the vehicle 602 may parse information (e.g., kinematics data) from the received messages. In some aspects, the ego vehicle 602 may also receive kinematics data associated with the vehicle 604A, the vehicle 604B, and the vehicle 604N based on message(s) from a RSU.

If the vehicle 602 evaluates that the surrounding vehicles have similar kinematics, the vehicle 602 may verify the characteristics of vehicles in its line-of-sight (LoS) using its own sensors to gain confidence in their kinematics. For example, the vehicle 602 may use one or all sensors (e.g., camera/Lidar/radar sensors) to verify and store relative speed/heading for all detected vehicles for a number of seconds and compare them with speeds and heading reported by each of the vehicles in respective BSM/CPM messages for x seconds. At 610, the vehicle 602 may verify the kinematics data associated with the vehicle 604A, the vehicle 604B, and the vehicle 604N. In some aspects, for each vehicle of the vehicle 604A, the vehicle 604B, and the vehicle 604N, the vehicle 602 may store the kinematics data and compare the stored kinematics data with camera, radar, Lidar, or other V2X sensor data to the kinematics data to verify relative or absolute speed, relative or absolute heading, or other kinematics data associated with the vehicle 604A, the vehicle 604B, and the vehicle 604N. For example, the kinematics data may be associated with a particular time period and the camera, radar, Lidar, or other V2X sensor data may be associated with another particular time period and the vehicle 602 may compare the kinematics data with the camera, radar, Lidar, or other V2X sensor data for an overlapping time period between the two time periods.

After verifying the kinematics data, at 612, the vehicle 602 may determine whether the vehicle 604A, the vehicle 604B, and the vehicle 604N is close enough in distance, speed, direction and non-malicious. If the vehicle 604A, the vehicle 604B, and the vehicle 604N are malicious (e.g., not candidates for forming a platoon), the vehicle 602 may attempt to restart the process to identify potential non-malicious vehicles. If the vehicle 604A, the vehicle 604B, and the vehicle 604N are non-malicious (e.g., suitable candidates for forming a platoon), in some aspects, the vehicle 602 may broadcast a request message 614 to each of the vehicle 604A, the vehicle 604B, and the vehicle 604N. The request message 614 may be a request to the surrounding vehicles for creating a platoon using the MSCM. The request message 614 may describe the engagement maneuver to surrounding vehicles to come into platoon formation. Upon receiving the request message 614, each of the vehicle 604A, the vehicle 604B, and the vehicle 604N may determine whether to join the platoon and transmit a response message (e.g., also using MSCM). If all surrounding vehicles agree with the request, then the vehicle 602 may move into the requested position at 620. In some aspects, if a vehicle disagrees with the request or does not answer the request, then the MSCM request may be cancelled for that vehicle.

In some aspects, the vehicle 604A may transmit the response message 616A indicating accept, the vehicle 604B transmit the response message 616B indicating reject, and the vehicle 604N may transmit the response message 616C indicating accept. Therefore, the request may be canceled for the vehicle 604B. The vehicle 602 may host a voting process at 618 to vote for a platoon leader at 618 and may receive votes from the vehicle 604A and the vehicle 604N with regard to which vehicle may be the platoon leader. For example, the leader of the platoon may be decided based on estimating the most efficient leader to follow. In some aspects, after forming the platoon, at 620, each of the vehicle 602, the vehicle 604A, and the vehicle 604N may move according to a platoon formation lane and their respective positions in the platoon. Upon forming the platoon, the vehicle 602, the vehicle 604A, and the vehicle 604N may also generate and communicate based on a particular communication key unique for the platoon and may register cryptographic certificates associated with the vehicle 602, the vehicle 604A, and the vehicle 604N with the platoon.

In some aspects, to form the platoon, these three vehicles may add more vehicles by again starting from identification steps to formation steps and the vehicles in the platoon may calculate a trust score based on their information gathering in the identification stage. Based on the trust score, each platoon vehicle provides a vote for or against adding a certain vehicle to the platoon. Majority or unanimous votes in favor of adding a vehicle may allow the vehicle to join the platoon. Each vote is digitally signed by the corresponding voting vehicle so that votes can be verified and hinder repudiation.

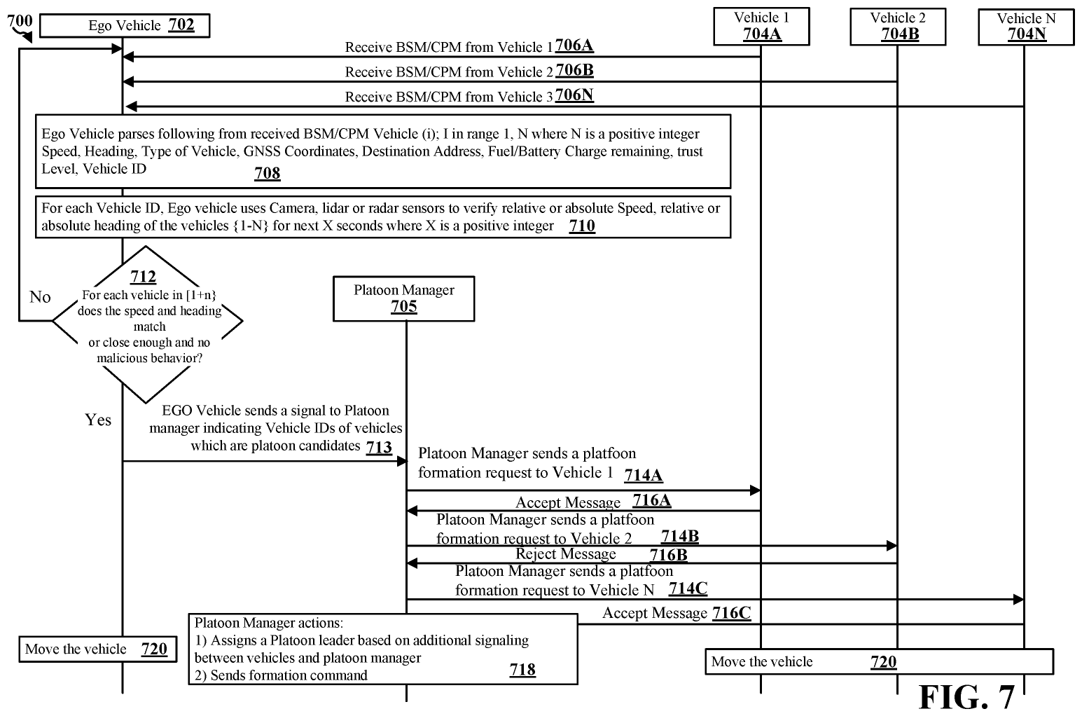

FIG. 7 is a diagram 700 illustrating communications between vehicles for platoon formation. As illustrated in FIG. 7, an ego vehicle 702 (e.g., which may be a vehicle to manage formation of a platoon) may identify one or more vehicles including a vehicle 704A, a vehicle 704B, and a vehicle 704N to be non-malicious. The vehicle 702 may be on the road and may passively monitor surrounding vehicles and tracks their kinematics for a number of seconds using V2X data it receives from basic safety messages and collective perception service. The parameters may include speed, heading, type of vehicle, GNSS coordinates, destination address, fuel or battery status, trust level, vehicle ID, or other kinematics data.

To identify the one or more vehicles including the vehicle 704A, the vehicle 704B, and the vehicle 704N to be non-malicious, the ego vehicle 702 may receive kinematics data associated with the vehicle 704A, the vehicle 704B, and the vehicle 704N. For example, the ego vehicle 702 may receive kinematics data associated with the vehicle 704A, the vehicle 704B, and the vehicle 704N based on a basic safety message (BSM) or a collective perception message (CPM) associated with the vehicle 704A, the vehicle 704B, and the vehicle 704N, such as a BSM/CPM 706A from the vehicle 704A, a BSM/CPM 706B from the vehicle 704B, and a BSM/CPM 706N from the vehicle 704N. In some aspects, upon receiving the BSM/CPM 706A from the vehicle 704A, the BSM/CPM 706B from the vehicle 704B, and the BSM/CPM 706N from the vehicle 704N, at 708, the vehicle 702 may parse information (e.g., kinematics data) from the received messages. In some aspects, the ego vehicle 702 may also receive kinematics data associated with the vehicle 704A, the vehicle 704B, and the vehicle 704N based on message(s) from a RSU.

If the vehicle 702 evaluates that the surrounding vehicles have similar kinematics, the vehicle 702 may verify the characteristics of vehicles in its line-of-sight (LoS) using its own sensors to gain confidence in their kinematics. For example, the vehicle 702 may use one or all sensors e.g.: camera/lidar/radar sensors to verify and store relative speed/heading for all detected vehicles for a number of seconds and compare them with speeds and heading reported by each of the vehicles in respective BSM/CPM messages for x seconds. At 710, the vehicle 702 may verify the kinematics data associated with the vehicle 704A, the vehicle 704B, and the vehicle 704N. In some aspects, for each vehicle of the vehicle 704A, the vehicle 704B, and the vehicle 704N, the vehicle 702 may store the kinematics data and compare the stored kinematics data with camera, radar, Lidar, or other V2X sensor data to the kinematics data to verify relative or absolute speed, relative or absolute heading, or other kinematics data associated with the vehicle 704A, the vehicle 704B, and the vehicle 704N. For example, the kinematics data may be associated with a particular time period and the camera, radar, Lidar, or other V2X sensor data may be associated with another particular time period and the vehicle 702 may compare the kinematics data with the camera, radar, Lidar, or other V2X sensor data for an overlapping time period between the two time periods.

After verifying the kinematics data, at 712, the vehicle 702 may determine whether the vehicle 704A, the vehicle 704B, and the vehicle 704N is close enough in distance, speed, direction and non-malicious. If the vehicle 704A, the vehicle 704B, and the vehicle 704N are malicious (e.g., not candidates for forming a platoon), the vehicle 702 may attempt to restart the process to identify potential non-malicious vehicles. If the vehicle 704A, the vehicle 704B, and the vehicle 704N are non-malicious (e.g., suitable candidates for forming a platoon), in some aspects, the vehicle 702 may transmit a signal 713 to a platoon manager 705, which may be a RSU, a network entity, another vehicle, or the like, to transmit request message 714A, request message 714B, and request message 714C to the vehicle 704A, the vehicle 704B, and the vehicle 704N. The request message 714A, request message 714B, and request message 714C may be a request to the surrounding vehicles for creating a platoon using the MSCM. The request message 714A, request message 714B, and request message 714C may describe the engagement maneuver to surrounding vehicles to come into platoon formation. Upon receiving the request message 714A, request message 714B, and request message 714C, each of the vehicle 704A, the vehicle 704B, and the vehicle 704N may determine whether to join the platoon and transmit a response message (e.g., also using MSCM). If all surrounding vehicles agree with the request, then the vehicle 702 may move into the requested position at 720. In some aspects, if a vehicle disagrees with the request or does not answer the request, then the MSCM request may be cancelled for that vehicle.

In some aspects, the vehicle 704A may transmit the response message 716A indicating accept, the vehicle 704B transmit the response message 716B indicating reject, and the vehicle 704N may transmit the response message 716C indicating accept. Therefore, the request may be canceled for the vehicle 704B. The platoon manager 705 may assign a platoon leader based on additional signaling between the platoon manager 705 and the vehicle 702, the vehicle 704A, or the vehicle 704N and transmit a formation command at 718. In some aspects, based on the formation command at 720, each of the vehicle 702, the vehicle 704A, and the vehicle 704N may move according to a platoon formation lane and their respective positions in the platoon. Upon forming the platoon, the vehicle 702, the vehicle 704A, and the vehicle 704N may also generate and communicate based on a particular communication key unique for the platoon and may register cryptographic certificates associated with the vehicle 702, the vehicle 704A, and the vehicle 704N with the platoon.

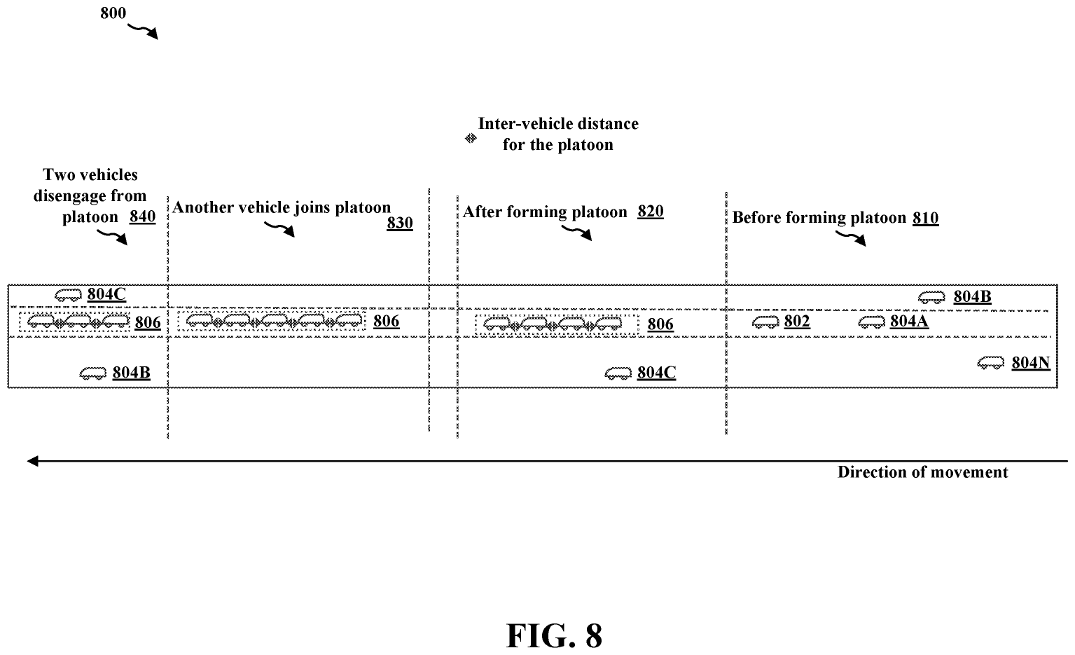

FIG. 8 is a diagram 800 illustrating movement of vehicles related to operations associated with a platoon. As illustrated in FIG. 8, before forming the platoon at 810, there may be a vehicle 802 (which may correspond to vehicle 602 or vehicle 702), a vehicle 804A (which may correspond to vehicle 604A or vehicle 704A), a vehicle 804B (which may correspond to vehicle 604B or vehicle 704B if the vehicle indicated accept), and a vehicle 804N (which may correspond to vehicle 604N or vehicle 704N). The vehicle 802, the vehicle 804A, the vehicle 804B, and the vehicle 804N may be heading towards a same direction and may be relatively close (e.g., based on a threshold) and may perform the steps described in connection with FIG. 6 or FIG. 7 to form a platoon. After forming the platoon at 820, the vehicle 802, the vehicle 804A, the vehicle 804B, and the vehicle 804N may move in a platoon 806 based on an inter-vehicle distance, an average speed, and a relative position in the platoon. In some aspects, the vehicle 802, the vehicle 804A, the vehicle 804B, and the vehicle 804N may identify another vehicle 804C as non-malicious and request the vehicle 804C to join the platoon. In some aspects, the vehicle 804C may request to join the platoon 810. In some aspects, after the vehicle 804C joins the platoon at 830, the platoon 806 may include the vehicle 802, the vehicle 804A, the vehicle 804B, and the vehicle 804C. In some aspects, at 840, the vehicle 804C and the vehicle 804B may request to depart from the platoon 806 and may accordingly depart from the platoon 806.

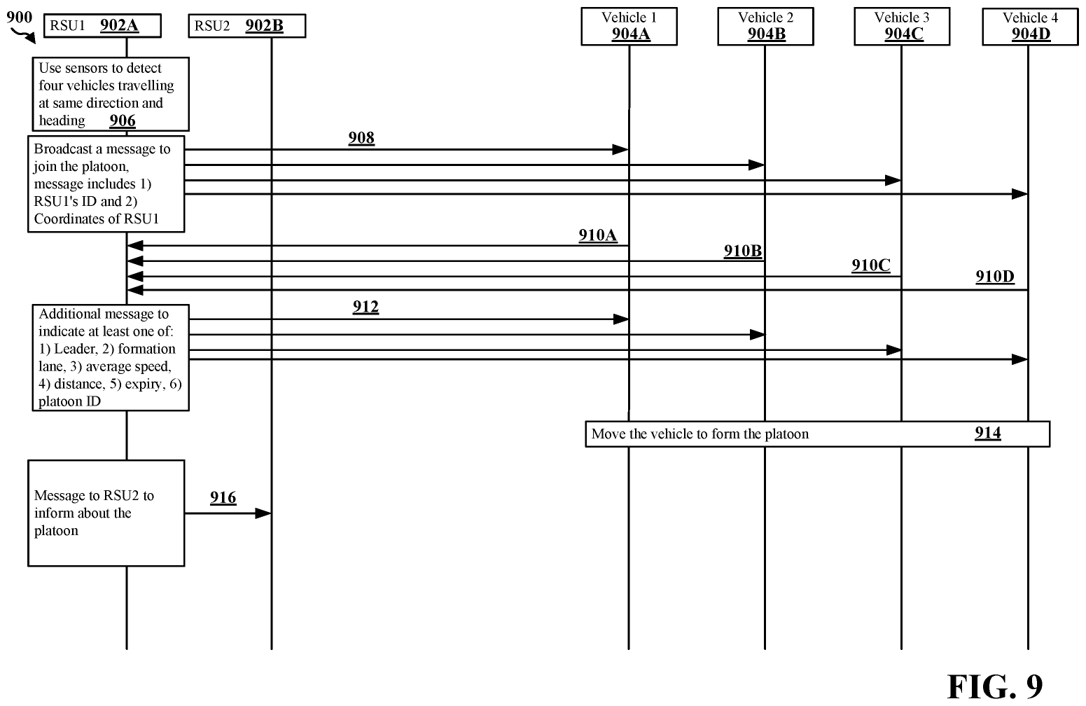

FIG. 9 is a diagram 900 illustrating communications between RSUs and vehicles for platoon formation. As illustrated in FIG. 9, a first RSU 902A and a second RSU 902B may be RSUs along a road. In some aspects, the RSU 902A and the RSU 902B are cloud connected traffic entities communicating over a communication interface. In some aspects, RSU 902A and RSU 902B may have two or more traffic cameras, radar, Lidar, vision sensors, or other sensors.

In some aspects, at 906, as four vehicles including a first vehicle 904A, a second vehicle 904B, a third vehicle 904C, and a fourth vehicle 904D approaches the first RSU, the first RSU 902A may use sensors to detect these four vehicles as travelling in a same direction and heading. The first RSU 902A may determine the first vehicle 904A, the second vehicle 904B, the third vehicle 904C, and the fourth vehicle 904D as non-malicious and may accordingly broadcast a request 908 to form a platoon. The request may include one or more of: a unique ID of the RSU, GNSS coordinates of the RSU, positioning related signaling parameters, cryptographic certificates, or the like. Upon receiving the request 908, the first vehicle 904A, the second vehicle 904B, the third vehicle 904C, and the fourth vehicle 904D may respectively transmit response 910A, response 910B, response 910C, and response 910D to reject or accept joining the platoon. In some aspects, the vehicles that accept may move forward with the next steps. The RSU 902A may transmit additional messages 912 to the vehicles that accept, additional information for the platoon such as: platoon leader, platoon formation lane, average speed, inter-vehicle distance, platoon ID, or the like. Based on the information received in the additional messages 912, the first vehicle 904A, the second vehicle 904B, the third vehicle 904C, and the fourth vehicle 904D may move at 914 to form the platoon. Platoon formation may traverse across RSUs. For example, if a platoon formation is not completed within the field-of-view of the RSU 902A, the RSU 902A may transmit message 916 including information regarding the platoon including the additional information and information regarding each of the first vehicle 904A, the second vehicle 904B, the third vehicle 904C, and the fourth vehicle 904D to the RSU 902B so that the RSU 902B may assist in the formation of the platoon. RSUs may be able to recognize which lanes are busy, such as due to construction or accident, so that other free lanes may be used to form the platoon. If the platoon formation is not completed, the RSU 902A may transmit the lane information regarding the platoon formation lane to the RSU 902B. The RSU 902B may make the decision to form the platoon in the same lane or determine and communicate a different platoon formation lane.

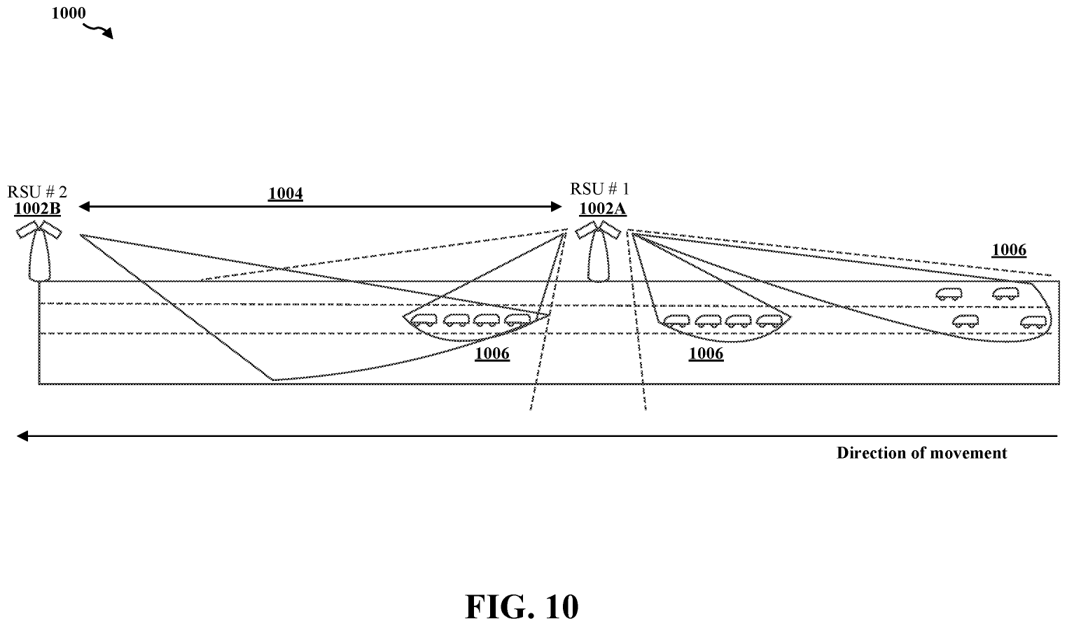

FIG. 10 is a diagram 1000 illustrating movement of vehicles related to operations associated with a platoon. As illustrated in FIG. 10, the RSU 1002A (which may correspond to RSU 902A) may detect four vehicles in a vicinity 1006 to be non-malicious and may facilitate platoon formation to make the four vehicles to form a platoon. As the four vehicles in the vicinity 1006 is completing formation of the platoon, the four vehicles may be leaving line-of-sight of the RSU 1002A so the RSU 1002A may transmit information regarding the four vehicles to the RSU 1002B in a message 1004. The RSU 1002B may further assist the formation of the platoon for the four vehicles in the vicinity 1006.

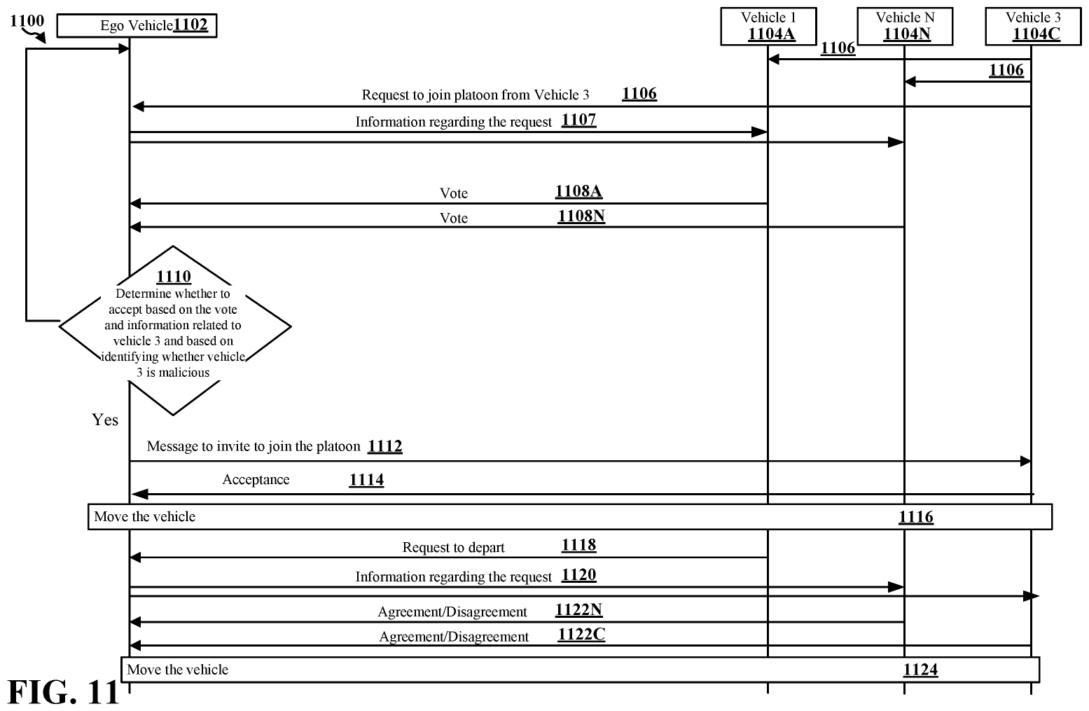

FIG. 11 is a diagram 1100 illustrating communications between vehicles related to disengagement of platoon and join of platoon. As illustrated in FIG. 11, an ego vehicle 1102, a vehicle 1104A and a vehicle 1104N may be already in a platoon. Another vehicle, vehicle 1104C, may be a potential candidate for joining the platoon. In some aspects, the vehicle 1104C may be interested in joining the platoon and may transmit a request 1106 to the ego vehicle 1102. In some aspects, upon receiving the request 1106, the vehicle 1102 may transmit a request message 1107 that includes information regarding the request to the vehicle 1104A and the vehicle 1104N. In some aspects, the request 1106 may be transmitted to the vehicle 1104A and the vehicle 1104N directly. In some aspects, each of the vehicle 1104A and the vehicle 1104N may identify, such as based on received kinematics data and based on verifying the kinematics data based on sensor data, whether the vehicle 1104C is non-malicious and transmit a respective vote 1108A and 1108N to the vehicle 1102. For example, the platoon leader may request votes from platoon participants. Platoon vehicles may monitor kinematics of the vehicle 1104C using V2X information and their sensors (e.g., camera, Lidar, radar, other V2X sensors) to verify it as non-malicious. The vehicle 1102 may also identify, such as based on received kinematics data and based on verifying the kinematics data based on sensor data, whether the vehicle 1104C is non-malicious at 1110 and determine whether to accept the request 1106 for joining the platoon based on the vote and the identification of whether vehicle 1104C is non-malicious. For example, each platoon vehicle may give a vote of confidence based on their own misbehavior detection mechanism, such as based on if 1104C had greater than a threshold percentage of messages tagged as genuine.

Platoon leader can decide based on the votes to initiate the joining procedure. If the vehicle 1102 determines to accept the request 1106 for joining the platoon, the vehicle 1102 may transmit a request message 1112 to invite the vehicle 1104C to join the platoon. The request message 1112 may describe the engagement maneuver for the platoon. The request message 1112 may facilitate the vehicle 1104C to match the speed of the platoon and move to a particular position in the platoon. In some aspects, without receiving a request 1106, the vehicle 1102, the vehicle 1104A, and the vehicle 1104N may also determine whether to invite the vehicle 1104C based on identifying non-malicious vehicles near the platoon. In some aspects, the vehicle 1104C may transmit a response message 1114 to indicate accepting the invite to join the platoon. The vehicle 1102, the vehicle 1104A, the vehicle 1104N, and the vehicle 1104C may accordingly move at 1116 to let the vehicle 1104C join the platoon. In some aspects, upon joining of the vehicle 1104C, cryptographic certificate of the vehicle 1104C may be registered and communication key may be updated for the platoon.

In some aspects, a platoon participant may request to break from its platoon due to any reason, such as it is approaching its destination and needs to take an exit. MSCS may be used to negotiate positions or speed of the platoon for safe disengagement from the platoon to not cause a breakage in the platoon while disengaging. As illustrated in FIG. 11, if the vehicle 1104A wants to depart from the platoon, the vehicle 1104A may transmit a request 1118, which may be an MSCM request to depart from the platoon. The platoon leader, which may be the vehicle 1102 may transmit information 1120 regarding the request to request, such as in another MSCM-request to the platoon describing the disengagement maneuver for each platoon member. Each platoon member answers the MSCM-request by sending an MSCM-response. For example, the vehicle 1104N may answer the MSCM request by transmitting a message 1122N indicating agreement or disagreement and the vehicle 1104C may answer the MSCM request by transmitting a message 1122C indicating agreement or disagreement. In some aspects, if all platoon members agree with the request, then the disengagement maneuver may start. In some aspects, if a platoon member disagrees with the request or does not answer the request, then the MSCM-request may be cancelled and a new MSCM-request for disengaging may be sent. In the meantime, the platoon vehicles can monitor the kinematics to verify the actions of the vehicle that wants to disengage. For example, any vehicle of the platoon can send a MSCM to update the status of the ongoing maneuver. For instance, a vehicle can send a MSCM to notify an incapability to perform the ongoing maneuver. A non-conform maneuver can be a reason to send a message to interrupt the ongoing maneuver.

If all members of the platoon agree to let the vehicle 1104A disengage, each of the vehicles in the platoon and the vehicle 1104A may move at 1124 based on the disengage maneuver. In some aspects, the platoon leader, which may be the vehicle 1102, may de-register departing vehicle's certificates to stop it from communicating with the platoon. The platoon may change communication keys and platoon ID after a vehicle breaks from the platoon, if their communication was encrypted.

Identifying bad actors in a platoon may be perform by all members of a platoon before, during, after joining, and after leaving a platoon. For example, a vehicle may observe the kinematics of all other members in the platoon via sensors (camera, Lidar, radar) or V2X data. The platoon members may calculate the mean and standard deviation of kinematic values (such as speed, acceleration and heading) of all vehicles from the data of all members. If any members' kinematics deviate more than a threshold, such as two standard deviations, that member may be deemed malicious (e.g., or incapable of being in the platoon) and may be voted out of the platoon. If the members are utilizing V2X information, the deviation threshold may be more stringent because V2X data may travel faster than processing sensor data. Vehicles may periodically verify credentials of other vehicles before adding and after forming the platoon with them. Platoon vehicles may form a group key to encrypt data transmission between the members so that vehicles external to the platoon don't interfere with their communication.

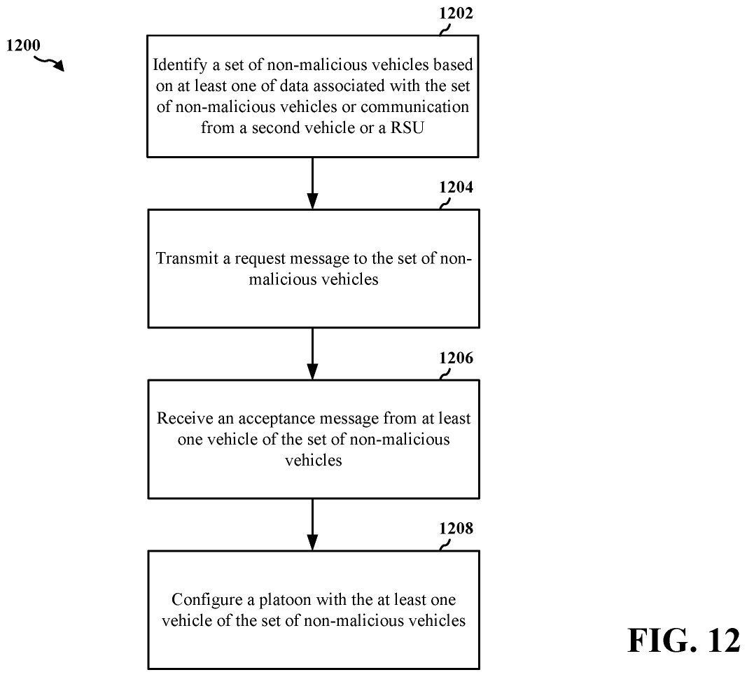

FIG. 12 is a flowchart 1200 of a method of platoon formation. The method may be performed by a vehicle (e.g., the UE 104, the vehicle 602, the vehicle 702, the vehicle 802, the vehicle 904A, 904B, 904C, or 904D, the vehicle 1102, another vehicle; the apparatus 1404).

At 1202, the vehicle may identify a set of non-malicious vehicles based on at least one of data associated with the set of non-malicious vehicles or communication from a second vehicle or a RSU. For example, the vehicle 602 may identify (e.g., at 612) a set of non-malicious vehicles (e.g., 604A, 604B, 604N) based on at least one of data associated with the set of non-malicious vehicles or communication from a second vehicle or a RSU (e.g., 606A, 606B, 606N). In some aspects, 1202 may be performed by platoon component 198.

At 1204, the vehicle may transmit a request message to the set of non-malicious vehicles. For example, the vehicle 602 may transmit a request message (e.g., 614) to the set of non-malicious vehicles. In some aspects, 1204 may be performed by platoon component 198.

At 1206, the vehicle may receive an acceptance message from at least one vehicle of the set of non-malicious vehicles. For example, the vehicle 602 may receive an acceptance message from at least one vehicle of the set of non-malicious vehicles. In some aspects, 1206 may be performed by platoon component 198.

At 1208, the vehicle may configure a platoon with the at least one vehicle of the set of non-malicious vehicles. For example, the vehicle 602 may configure a platoon (e.g., at 618 or 620) with the at least one vehicle of the set of non-malicious vehicles. In some aspects, 1208 may be performed by platoon component 198.

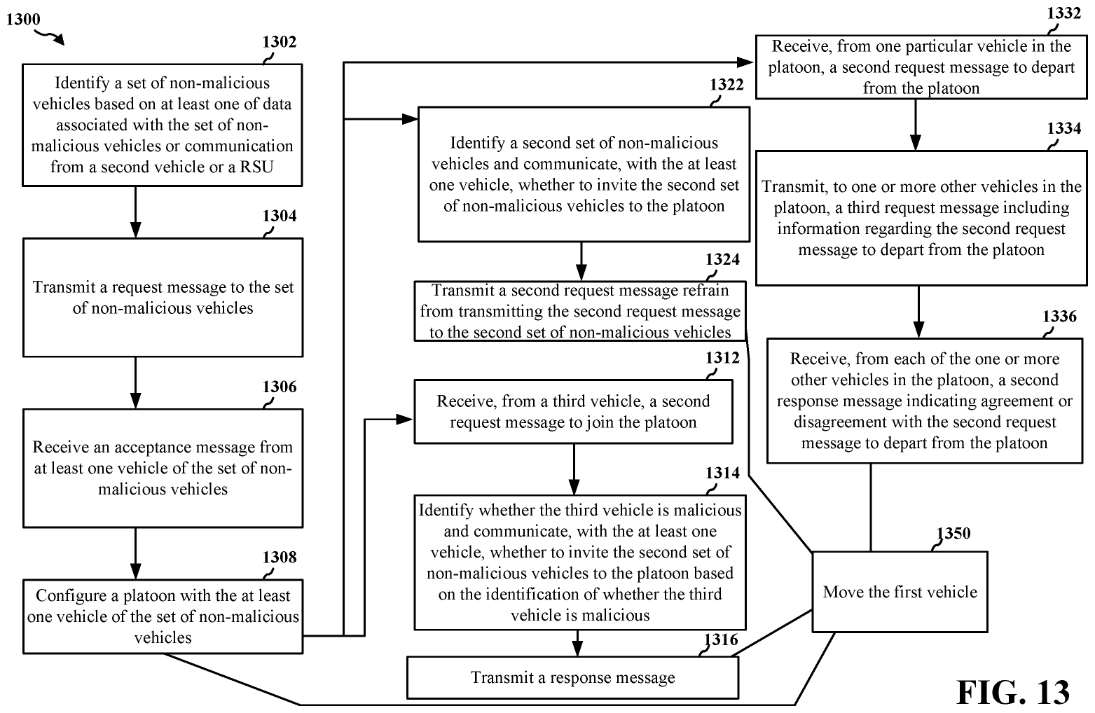

FIG. 13 is a flowchart 1300 of a method of platoon formation. The method may be performed by a vehicle (e.g., the UE 104, the vehicle 602, the vehicle 702, the vehicle 802. the vehicle 904A, 904B, 904C, or 904D, the vehicle 1102, another vehicle; the apparatus 1404).

At 1302, the vehicle may identify a set of non-malicious vehicles based on at least one of data associated with the set of non-malicious vehicles or communication from a second vehicle or a RSU. For example, the vehicle 602 may identify (e.g., at 612) a set of non-malicious vehicles (e.g., 604A, 604B, 604N) based on at least one of data associated with the set of non-malicious vehicles or communication from a second vehicle or a RSU (e.g., 606A, 606B, 606N). In some aspects, 1302 may be performed by platoon component 198.

In some aspects, to identify the set of non-malicious vehicles, the vehicle may monitor kinematics data associated with a set of vehicles including the set of non-malicious vehicles, where the kinematics data is associated with the set of vehicles for a period of time. The vehicle may identify the set of non-malicious vehicles based on the kinematics data. In some aspects, to monitor the kinematics data, the vehicle may monitor the kinematics data based on a set of basic safety messages (e.g., 606A, 606B, 606N) of a collective perception service, where the communication from the second vehicle or the RSU corresponds to a basic safety message of the set of basic safety messages or a message for the collective perception service.

In some aspects, the kinematics data includes at least one of: a speed associated with a respective vehicle of the set of vehicles, an acceleration associated with the respective vehicle of the set of vehicles, a heading direction associated with the respective vehicle of the set of vehicles, a vehicle type associated with the respective vehicle of the set of vehicles, a set of GNSS coordinates associated with the respective vehicle of the set of vehicles, a vehicle ID associated with the respective vehicle of the set of vehicles, a destination address associated with the respective vehicle of the set of vehicles, a fuel or battery status associated with the respective vehicle of the set of vehicles, or a trust level associated with the respective vehicle of the set of vehicles.

In some aspects, to identify the set of non-malicious vehicles based on the kinematics data, the vehicle may also verify the kinematics data associated with a subset of vehicles of the set of vehicles based on at least one camera, at least one Lidar sensor, at least one radar sensor, or at least one V2X sensor associated with the first vehicle, where the subset of vehicles is within a line of sight (LoS) of the first vehicle. For example, the vehicle 602 may verify the kinematics data (e.g., based on 606A, 606B, or 606N) associated with a subset of vehicles of the set of vehicles monitored based on at least one camera, at least one Lidar sensor, at least one radar sensor, or at least one V2X sensor associated with the vehicle 602. To verify the kinematics data associated with the subset of vehicles, the vehicle may store the kinematics data, generate second kinematics data associated with the subset of vehicles for a second period of time based on the at least one camera, the at least one Lidar sensor, the at least one radar sensor, or the at least one V2X sensor, and compare the kinematics data with the second kinematics data to verify the kinematics data associated with the subset of vehicles in an overlapping portion of the period of time and the second period of time.

In some aspects, to identify the set of non-malicious vehicles, the at least one processor, the vehicle may receive the communication from the RSU, where the communication includes a request to configure the platoon and at least one of: a ID associated with the RSU, a set of GNSS coordinates associated with the RSU, a set of positioning related signaling parameters, or a set of cryptographic certificates associated with the RSU or the set of non-malicious vehicles.

In some aspects, the first vehicle may receive, from the RSU, information regarding at least one of: a platoon leader associated with the platoon, a platoon formation lane associated with the platoon, an average speed associated with the platoon, an inter-vehicle distance associated with the platoon, or a platoon ID associated with the platoon. For example, the vehicle 904A may receive information regarding at least one of: a platoon leader associated with the platoon, a platoon formation lane associated with the platoon, an average speed associated with the platoon, an inter-vehicle distance associated with the platoon, or a platoon ID associated with the platoon in 908 or 912.

At 1304, the vehicle may transmit a request message to the set of non-malicious vehicles. For example, the vehicle 602 may transmit a request message (e.g., 614) to the set of non-malicious vehicles. In some aspects, 1304 may be performed by platoon component 198. In some aspects, the request message is a MSCM request including information regarding at least one of: a platoon leader associated with the platoon, a platoon formation lane associated with the platoon, an average speed associated with the platoon, an inter-vehicle distance associated with the platoon, or a platoon ID associated with the platoon, and where the acceptance message is a MSCM response.

At 1306, the vehicle may receive an acceptance message from at least one vehicle of the set of non-malicious vehicles. For example, the vehicle 602 may receive an acceptance message from at least one vehicle of the set of non-malicious vehicles. In some aspects, 1306 may be performed by platoon component 198.

At 1308, the vehicle may configure a platoon with the at least one vehicle of the set of non-malicious vehicles. For example, the vehicle 602 may configure a platoon (e.g., at 618 or 620) with the at least one vehicle of the set of non-malicious vehicles. In some aspects, 1308 may be performed by platoon component 198. In some aspects, to configure the platoon, the vehicle may move (e.g., at 620) to a position on the platoon formation lane and may configure a communication key for the platoon with the at least one vehicle. In some aspects, 1350 may be performed by platoon component 198.

In some aspects, to configure the platoon, the vehicle may receive, from the at least one vehicle, an approximate destination and a proposal regarding the platoon leader and may transmit a vote for the platoon leader to the at least one vehicle. For example, the vehicle 602 may receive, from the at least one vehicle, an approximate destination and a proposal regarding the platoon leader and may transmit a vote for the platoon leader to the at least one vehicle as part of the voting process at 618. In some aspects, to configure the platoon, the vehicle may register a cryptographic certificate associated with the at least one vehicle and configure a communication key for the platoon.

In some aspects, at 1312, the vehicle may receive, from a third vehicle, a second request message (e.g., 1106) to join the platoon. In some aspects, at 1314, the vehicle may identify whether the third vehicle is malicious and communicate, with the at least one vehicle, whether to invite (e.g., 1108A or 1108N) the second set of non-malicious vehicles to the platoon based on the identification of whether the third vehicle is malicious. In some aspects, at 1316, the vehicle may transmit a second response message (e.g., 1112) to the third vehicle to allow the third vehicle to join the platoon or refrain from transmitting the second response message to the third vehicle based on the communication of whether to invite the third vehicle to the platoon. In some aspects, the second response message (e.g., 1112) includes a position in the platoon associated with the third vehicle and a speed associated with the platoon. In some aspects, the vehicle may register a cryptographic certificate associated with the third vehicle and configure an updated communication key for the platoon with the at least one vehicle and the third vehicle. In some aspects, 1312 may be performed by platoon component 198. In some aspects, 1314 may be performed by platoon component 198. In some aspects, 1316 may be performed by platoon component 198.

At 1322, the vehicle may identify a second set of non-malicious vehicles. For example, the vehicle 1102 may identify (e.g., at 1110) a second set of non-malicious vehicles. In some aspects, 1322 may be performed by platoon component 198. In some aspects, the vehicle may also communicate, with the at least one vehicle, trust information (e.g., 1107) regarding the second set of non-malicious vehicles. In some aspects, the vehicle may communicate, with the at least one vehicle, whether to invite (e.g., 1108A or 1108N) the second set of non-malicious vehicles to the platoon. At 1324, the vehicle may transmit a second request message to the second set of non-malicious vehicles or refrain from transmitting the second request message to the second set of non-malicious vehicles based on whether to invite the second set of non-malicious vehicles to the platoon. For example, the vehicle 1102 may transmit a second request message (e.g., 1112) to the second set of non-malicious vehicles or refrain from transmitting the second request message to the second set of non-malicious vehicles based on whether to invite the second set of non-malicious vehicles to the platoon. In some aspects, 1324 may be performed by platoon component 198. In some aspects, the vehicle may receive, from at least one other vehicle (e.g., 604B) of the set of non-malicious vehicles, a denial message (e.g., 616B) indicating a lack of joining the platoon.

At 1332, the vehicle may receive, from one particular vehicle in the platoon, a second request message to depart from the platoon. For example, the vehicle 1102 may receive, from one particular vehicle in the platoon, a second request message (e.g., 1118) to depart from the platoon. In some aspects, 1332 may be performed by platoon component 198.

At 1334, the vehicle may transmit, to one or more other vehicles in the platoon, a third request message including information regarding the second request message to depart from the platoon. For example, the vehicle 1102 may transmit, to one or more other vehicles in the platoon, a third request message including information (e.g., 1120) regarding the second request message to depart from the platoon. In some aspects, 1334 may be performed by platoon component 198.

At 1336, the vehicle may receive, from each of the one or more other vehicles in the platoon, a second response message indicating agreement or disagreement with the second request message to depart from the platoon. For example, the vehicle 602 may receive, from each of the one or more other vehicles in the platoon, a second response message indicating agreement or disagreement (e.g., 1122C or 1122N) with the second request message to depart from the platoon. In some aspects, 1336 may be performed by platoon component 198. In some aspects, the second request message is a MSCM request, where the third request message is a second MSCM request, and where the second response message is a MSCM response. In some aspects, the second response from each of the one or more other vehicles in the platoon indicates agreement with the second request message to depart from the platoon, and the vehicle may move the first vehicle based on a departure of the one particular vehicle (e.g., at 1124).

In some aspects, the second response from each of the one or more other vehicles in the platoon indicates agreement, and the vehicle may deregister a cryptographic certificate associated with the one particular vehicle and configure an updated communication key for the platoon without the one particular vehicle.

In some aspects, the vehicle may communicate, with the at least one vehicle, kinematics data regarding the at least one vehicle and the first vehicle to identify malicious behavior associated with the at least one vehicle or the first vehicle and may communicate, with the at least one vehicle, whether to remove a particular vehicle from the platoon based on the particular vehicle being associated with the malicious behavior. In some aspects, the communication of whether to remove the particular vehicle from the platoon based on the particular vehicle being associated with the malicious behavior is based on the kinematics data associated with the particular vehicle compared with a standard deviation associated with the kinematics data regarding the at least one vehicle and the first vehicle.

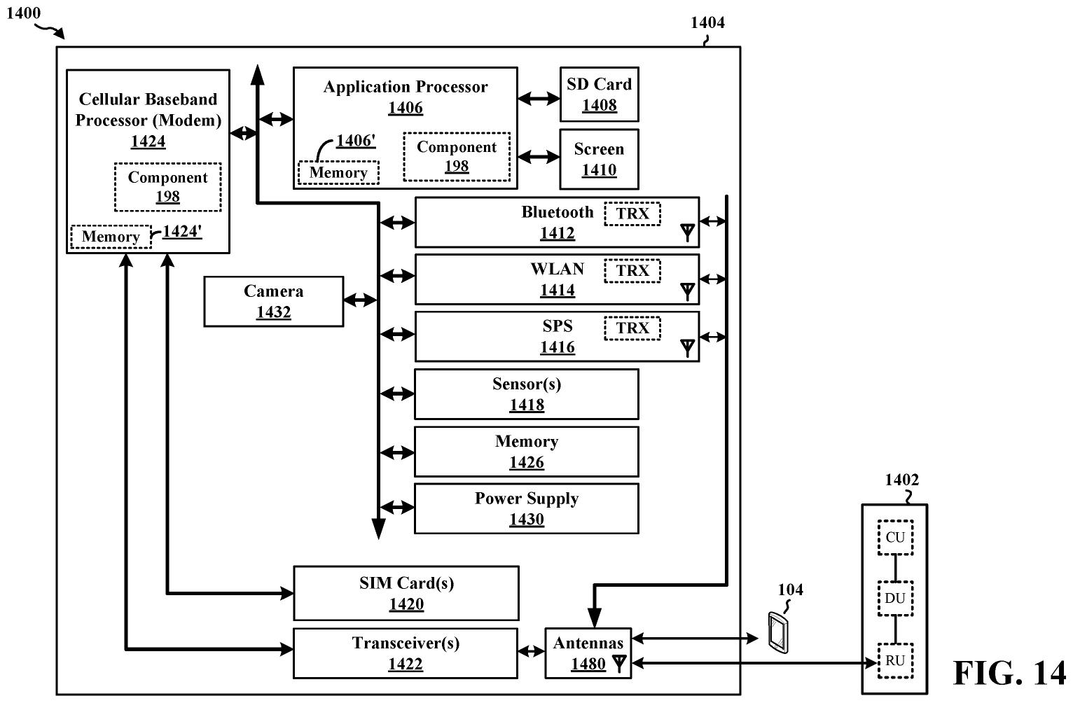

FIG. 14 is a diagram 1400 illustrating an example of a hardware implementation for an apparatus 1404. The apparatus 1404 may be a UE, a component of a UE, or may implement UE functionality. In some aspects, the apparatus 1404 may include at least one cellular baseband processor 1424 (also referred to as a modem) coupled to one or more transceivers 1422 (e.g., cellular RF transceiver). The cellular baseband processor(s) 1424 may include at least one on-chip memory 1424′. In some aspects, the apparatus 1404 may further include one or more subscriber identity modules (SIM) cards 1420 and at least one application processor 1406 coupled to a secure digital (SD) card 1408 and a screen 1410. The application processor(s) 1406 may include on-chip memory 1406′. In some aspects, the apparatus 1404 may further include a Bluetooth module 1412, a WLAN module 1414, an SPS module 1416 (e.g., GNSS module), one or more sensor modules 1418 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1426, a power supply 1430, and/or a camera 1432. The Bluetooth module 1412, the WLAN module 1414, and the SPS module 1416 may include an on-chip transceiver (TRX) (or in some cases, just a receiver (RX)). The Bluetooth module 1412, the WLAN module 1414, and the SPS module 1416 may include their own dedicated antennas and/or utilize the antennas 1480 for communication. The cellular baseband processor(s) 1424 communicates through the transceiver(s) 1422 via one or more antennas 1480 with the UE 104 and/or with an RU associated with a network entity 1402. The cellular baseband processor(s) 1424 and the application processor(s) 1406 may each include a computer-readable medium/memory 1424′, 1406′, respectively. The additional memory modules 1426 may also be considered a computer-readable medium/memory. Each computer-readable medium/memory 1424′, 1406′, 1426 may be non-transitory. The cellular baseband processor(s) 1424 and the application processor(s) 1406 are each responsible for general processing, including the execution of software stored on the computer-readable medium/memory. The software, when executed by the cellular baseband processor(s) 1424/application processor(s) 1406, causes the cellular baseband processor(s) 1424/application processor(s) 1406 to perform the various functions described supra. The computer-readable medium/memory may also be used for storing data that is manipulated by the cellular baseband processor(s) 1424/application processor(s) 1406 when executing software. The cellular baseband processor(s) 1424/application processor(s) 1406 may be a component of the device 350 and may include the at least one memory 360 and/or at least one of the TX processor 368, the RX processor 356, and the controller/processor 359. In one configuration, the apparatus 1404 may be at least one processor chip (modem and/or application) and include just the cellular baseband processor(s) 1424 and/or the application processor(s) 1406, and in another configuration, the apparatus 1404 may be the entire UE (e.g., see device 350 of FIG. 3) and include the additional modules of the apparatus 1404.

As discussed supra, the platoon component 198 may be configured to identify a set of non-malicious vehicles based on at least one of data associated with the set of non-malicious vehicles or communication from a second vehicle or a RSU. In some aspects, the platoon component 198 may be further configured to transmit a request message to the set of non-malicious vehicles. In some aspects, the platoon component 198 may be further configured to receive an acceptance message from at least one vehicle of the set of non-malicious vehicles. In some aspects, the platoon component 198 may be further configured to configure a platoon with the at least one vehicle of the set of non-malicious vehicles. The platoon component 198 may be within the cellular baseband processor(s) 1424, the application processor(s) 1406, or both the cellular baseband processor(s) 1424 and the application processor(s) 1406. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1404 may include a variety of components configured for various functions. In one configuration, the apparatus 1404, and in particular the cellular baseband processor(s) 1424 and/or the application processor(s) 1406, may include means for identifying a set of non-malicious vehicles based on at least one of data associated with the set of non-malicious vehicles or communication from a second vehicle or a RSU. In some aspects, the apparatus 1404 may include means for transmitting a request message to the set of non-malicious vehicles. In some aspects, the apparatus 1404 may include means for receiving an acceptance message from at least one vehicle of the set of non-malicious vehicles. In some aspects, the apparatus 1404 may include means for configuring a platoon with the at least one vehicle of the set of non-malicious vehicles. In some aspects, the apparatus 1404 may include means for monitoring kinematics data associated with a set of vehicles including the set of non-malicious vehicles, where the kinematics data is associated with the set of vehicles for a period of time. In some aspects, the apparatus 1404 may include means for identifying the set of non-malicious vehicles based on the kinematics data. In some aspects, the apparatus 1404 may include means for monitoring the kinematics data based on a set of basic safety messages or a collective perception service, where the communication from the second vehicle or the RSU corresponds to a basic safety message of the set of basic safety messages or a message for the collective perception service. In some aspects, the apparatus 1404 may include means for verifying the kinematics data associated with a subset of vehicles of the set of vehicles based on at least one camera, at least one light detection and ranging (Lidar) sensor, at least one radio detection and ranging (radar) sensor, or at least one vehicle to everything (V2X) sensor associated with the first vehicle, where the subset of vehicles is within a line of sight (LoS) of the first vehicle. In some aspects, the apparatus 1404 may include means for storing the kinematics data. In some aspects, the apparatus 1404 may include means for generating second kinematics data associated with the subset of vehicles for a second period of time based on the at least one camera, the at least one Lidar sensor, the at least one radar sensor, or the at least one V2X sensor. In some aspects, the apparatus 1404 may include means for comparing the kinematics data with the second kinematics data to verify the kinematics data associated with the subset of vehicles in an overlapping portion of the period of time and the second period of time. In some aspects, the apparatus 1404 may include means for receiving the communication from the RSU, where the communication includes a request to configure the platoon and at least one of: an identifier (ID) associated with the RSU, a set of global navigation satellite system (GNSS) coordinates associated with the RSU, a set of positioning related signaling parameters, or a set of cryptographic certificates associated with the RSU or the set of non-malicious vehicles. In some aspects, the apparatus 1404 may include means for receiving, from the RSU, information regarding at least one of: a platoon leader associated with the platoon, a platoon formation lane associated with the platoon, an average speed associated with the platoon, an inter-vehicle distance associated with the platoon, or a platoon ID associated with the platoon. In some aspects, the apparatus 1404 may include means for moving the first vehicle to a position on the platoon formation lane. In some aspects, the apparatus 1404 may include means for configuring a communication key for the platoon with the at least one vehicle. In some aspects, the apparatus 1404 may include means for receiving, from the at least one vehicle, an approximate destination and a proposal regarding the platoon leader. In some aspects, the apparatus 1404 may include means for transmitting a vote for the platoon leader to the at least one vehicle. In some aspects, the apparatus 1404 may include means for identifying a second set of non-malicious vehicles. In some aspects, the apparatus 1404 may include means for communicating, with the at least one vehicle, trust information regarding the second set of non-malicious vehicles. In some aspects, the apparatus 1404 may include means for communicating, with the at least one vehicle, whether to invite the second set of non-malicious vehicles to the platoon. In some aspects, the apparatus 1404 may include means for transmitting a second request message to the second set of non-malicious vehicles or refrain from transmitting the second request message to the second set of non-malicious vehicles based on whether to invite the second set of non-malicious vehicles to the platoon. In some aspects, the apparatus 1404 may include means for receiving, from at least one other vehicle of the set of non-malicious vehicles, a denial message indicating a lack of joining the platoon. In some aspects, the apparatus 1404 may include means for receiving, from a third vehicle, a second request message to join the platoon. In some aspects, the apparatus 1404 may include means for identifying whether the third vehicle is malicious. In some aspects, the apparatus 1404 may include means for communicating, with the at least one vehicle, whether to invite the second set of non-malicious vehicles to the platoon based on the identification of whether the third vehicle is malicious. In some aspects, the apparatus 1404 may include means for transmitting a second response message to the third vehicle to allow the third vehicle to join the platoon or refrain from transmitting the second response message to the third vehicle based on the communication of whether to invite the third vehicle to the platoon. In some aspects, the apparatus 1404 may include means for registering a cryptographic certificate associated with the third vehicle. In some aspects, the apparatus 1404 may include means for configuring an updated communication key for the platoon with the at least one vehicle and the third vehicle. In some aspects, the apparatus 1404 may include means for receiving, from one particular vehicle in the platoon, a second request message to depart from the platoon. In some aspects, the apparatus 1404 may include means for transmitting, to one or more other vehicles in the platoon, a third request message including information regarding the second request message to depart from the platoon. In some aspects, the apparatus 1404 may include means for receiving, from each of the one or more other vehicles in the platoon, a second response message indicating agreement or disagreement with the second request message to depart from the platoon. In some aspects, the apparatus 1404 may include means for moving the first vehicle based on a departure of the one particular vehicle. In some aspects, the apparatus 1404 may include means for deregistering a cryptographic certificate associated with the one particular vehicle. In some aspects, the apparatus 1404 may include means for configuring an updated communication key for the platoon without the one particular vehicle. In some aspects, the apparatus 1404 may include means for communicating, with the at least one vehicle, kinematics data regarding the at least one vehicle and the first vehicle to identify malicious behavior associated with the at least one vehicle or the first vehicle. In some aspects, the apparatus 1404 may include means for communicating, with the at least one vehicle, whether to remove a particular vehicle from the platoon based on the particular vehicle being associated with the malicious behavior. In some aspects, the apparatus 1404 may include means for registering a cryptographic certificate associated with the at least one vehicle. In some aspects, the apparatus 1404 may include means for configuring a communication key for the platoon. The means may be the component 198 of the apparatus 1404 configured to perform the functions recited by the means. As described supra, the apparatus 1404 may include the TX processor 368, the RX processor 356, and the controller/processor 359. As such, in one configuration, the means may be the TX processor 368, the RX processor 356, and/or the controller/processor 359 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C. where any such combinations may contain one or more member or members of A, B, or C. Sets should be interpreted as a set of elements where the elements number one or more. Accordingly, for a set of X. X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.
Aspect 1 is a method for platoon formation at a first vehicle, including: identifying a set of non-malicious vehicles based on at least one of data associated with the set of non-malicious vehicles or communication from a second vehicle or a RSU; transmitting a request message to the set of non-malicious vehicles; receiving an acceptance message from at least one vehicle of the set of non-malicious vehicles; and configuring a platoon with the at least one vehicle of the set of non-malicious vehicles.
Aspect 2 is the method of aspect 1, where identifying the set of non-malicious vehicles further includes: monitoring kinematics data associated with a set of vehicles including the set of non-malicious vehicles, where the kinematics data is associated with the set of vehicles for a period of time; and identifying the set of non-malicious vehicles based on the kinematics data.
Aspect 3 is the method of aspect 2, where monitoring the kinematics data further includes: monitoring the kinematics data based on a set of basic safety messages or a collective perception service, where the communication from the second vehicle or the RSU corresponds to a basic safety message of the set of basic safety messages or a message for the collective perception service.
Aspect 4 is the method of any of aspects 2-3, where the kinematics data includes at least one of: a speed associated with a respective vehicle of the set of vehicles, an acceleration associated with the respective vehicle of the set of vehicles, a heading direction associated with the respective vehicle of the set of vehicles, a vehicle type associated with the respective vehicle of the set of vehicles, a set of global navigation satellite system (GNSS) coordinates associated with the respective vehicle of the set of vehicles, a vehicle identifier (ID) associated with the respective vehicle of the set of vehicles, a destination address associated with the respective vehicle of the set of vehicles, a fuel or battery status associated with the respective vehicle of the set of vehicles, or a trust level associated with the respective vehicle of the set of vehicles.
Aspect 5 is the method of any of aspects 2-4, where identifying the set of non-malicious vehicles based on the kinematics data further includes: verifying the kinematics data associated with a subset of vehicles of the set of vehicles based on at least one camera, at least one light detection and ranging (Lidar) sensor, at least one radio detection and ranging (radar) sensor, or at least one vehicle to everything (V2X) sensor associated with the first vehicle, where the subset of vehicles is within a line of sight (LoS) of the first vehicle.
Aspect 6 is the method of aspect 5, where verifying the kinematics data associated with the subset of vehicles further includes: storing the kinematics data; generating second kinematics data associated with the subset of vehicles for a second period of time based on the at least one camera, the at least one Lidar sensor, the at least one radar sensor, or the at least one V2X sensor; and comparing the kinematics data with the second kinematics data to verify the kinematics data associated with the subset of vehicles in an overlapping portion of the period of time and the second period of time.
Aspect 7 is the method of any of aspects 1-6, where identifying the set of non-malicious vehicles further includes: receiving the communication from the RSU, where the communication includes a request to configure the platoon and at least one of: an identifier (ID) associated with the RSU, a set of global navigation satellite system (GNSS) coordinates associated with the RSU, a set of positioning related signaling parameters, or a set of cryptographic certificates associated with the RSU or the set of non-malicious vehicles.
Aspect 8 is the method of any of aspects 1-7, further including: receiving, from the RSU, information regarding at least one of: a platoon leader associated with the platoon, a platoon formation lane associated with the platoon, an average speed associated with the platoon, an inter-vehicle distance associated with the platoon, or a platoon identifier (ID) associated with the platoon.
Aspect 9 is the method of any of aspects 1-8, where the request message is a maneuver sharing and coordination message (MSCM) request including information regarding at least one of: a platoon leader associated with the platoon, a platoon formation lane associated with the platoon, an average speed associated with the platoon, an inter-vehicle distance associated with the platoon, or a platoon identifier (ID) associated with the platoon, and where the acceptance message is a MSCM response.
Aspect 10 is the method of aspect 9, where configuring the platoon further includes: moving the first vehicle to a position on the platoon formation lane; and configuring a communication key for the platoon with the at least one vehicle.
Aspect 11 is the method of any of aspects 9-10, where configuring the platoon further includes: receiving, from the at least one vehicle, an approximate destination and a proposal regarding the platoon leader; and transmitting a vote for the platoon leader to the at least one vehicle.
Aspect 12 is the method of any of aspects 1-11, further including: identifying a second set of non-malicious vehicles; communicating, with the at least one vehicle, trust information regarding the second set of non-malicious vehicles; communicating, with the at least one vehicle, whether to invite the second set of non-malicious vehicles to the platoon; and transmitting a second request message to the second set of non-malicious vehicles or refrain from transmitting the second request message to the second set of non-malicious vehicles based on whether to invite the second set of non-malicious vehicles to the platoon.
Aspect 13 is the method of any of aspects 1-12, further including: receiving, from at least one other vehicle of the set of non-malicious vehicles, a denial message indicating a lack of joining the platoon.
Aspect 14 is the method of any of aspects 1-13, further including: receiving, from a third vehicle, a second request message to join the platoon; identifying whether the third vehicle is malicious; communicating, with the at least one vehicle, whether to invite the second set of non-malicious vehicles to the platoon based on the identification of whether the third vehicle is malicious; and transmitting a second response message to the third vehicle to allow the third vehicle to join the platoon or refrain from transmitting the second response message to the third vehicle based on the communication of whether to invite the third vehicle to the platoon.
Aspect 15 is the method of aspect 14, where the second response message includes a position in the platoon associated with the third vehicle and a speed associated with the platoon.
Aspect 16 is the method of aspect 15, further including: registering a cryptographic certificate associated with the third vehicle; and configuring an updated communication key for the platoon with the at least one vehicle and the third vehicle.
Aspect 17 is the method of any of aspects 1-16, further including: receiving, from one particular vehicle in the platoon, a second request message to depart from the platoon; transmitting, to one or more other vehicles in the platoon, a third request message including information regarding the second request message to depart from the platoon; and receiving, from each of the one or more other vehicles in the platoon, a second response message indicating agreement or disagreement with the second request message to depart from the platoon.
Aspect 18 is the method of aspect 17, where the second request message is a maneuver sharing and coordination message (MSCM) request, where the third request message is a second MSCM request, and where the second response message is a MSCM response.
Aspect 19 is the method of any of aspects 17-18, where the second response from each of the one or more other vehicles in the platoon indicates agreement with the second request message to depart from the platoon, and further including: moving the first vehicle based on a departure of the one particular vehicle.
Aspect 20 is the method of any of aspects 17-19, where the second response from each of the one or more other vehicles in the platoon indicates agreement, and further including: deregistering a cryptographic certificate associated with the one particular vehicle; and configuring an updated communication key for the platoon without the one particular vehicle.
Aspect 21 is the method of any of aspects 1-20, further including: communicating, with the at least one vehicle, kinematics data regarding the at least one vehicle and the first vehicle to identify malicious behavior associated with the at least one vehicle or the first vehicle; and communicating, with the at least one vehicle, whether to remove a particular vehicle from the platoon based on the particular vehicle being associated with the malicious behavior.
Aspect 22 is the method of aspect 21, where the communication of whether to remove the particular vehicle from the platoon based on the particular vehicle being associated with the malicious behavior is based on the kinematics data associated with the particular vehicle compared with a standard deviation associated with the kinematics data regarding the at least one vehicle and the first vehicle.
Aspect 23 is the method of any of aspects 1-22, where configuring the platoon further includes: registering a cryptographic certificate associated with the at least one vehicle; and configuring a communication key for the platoon.
Aspect 24 is the method of any of aspects 1-23, further including transmitting the request message via at least one of a transceiver or an antenna.
Aspect 25 is an apparatus for platoon formation at a device including at least one memory and at least one processor coupled to the at least one memory and, the at least one processor, individually or in any combination, based at least in part on information stored in the at least one memory, the at least one processor is configured to implement any of aspects 1 to 24.
Aspect 26 is the apparatus of aspect 25, further including one or more transceivers or one or more antennas coupled to the at least one processor.
Aspect 27 is an apparatus for platoon formation at a device including means for implementing any of aspects 1 to 24.
Aspect 28 is a computer-readable medium (e.g., a non-transitory computer-readable medium) storing computer executable code, where the code when executed by at least one processor causes the at least one processor to implement any of aspects 1 to 24.

What is claimed is:

1. An apparatus for platoon formation at a first vehicle, comprising:
at least one memory; and
at least one processor coupled to the at least one memory and, based at least in part on information stored in the at least one memory, the at least one processor, individually or in any combination, is configured to:
identify a set of non-malicious vehicles based on at least one of data associated with the set of non-malicious vehicles or communication from a second vehicle or a road side unit (RSU);
transmit a request message to the set of non-malicious vehicles;
receive an acceptance message from at least one vehicle of the set of non-malicious vehicles; and
configure a platoon with the at least one vehicle of the set of non-malicious vehicles.

2. The apparatus of claim 1, wherein to identify the set of non-malicious vehicles, the at least one processor, individually or in any combination, is configured to:
monitor kinematics data associated with a set of vehicles including the set of non-malicious vehicles, wherein the kinematics data is associated with the set of vehicles for a period of time; and
identify the set of non-malicious vehicles based on the kinematics data.

3. The apparatus of claim 2, wherein to monitor the kinematics data, the at least one processor, individually or in any combination, is configured to:
monitor the kinematics data based on a set of basic safety messages or a collective perception service, wherein the communication from the second vehicle or the RSU corresponds to a basic safety message of the set of basic safety messages or a message for the collective perception service.

4. The apparatus of claim 2, wherein the kinematics data comprises at least one of:
a speed associated with a respective vehicle of the set of vehicles,
an acceleration associated with the respective vehicle of the set of vehicles,
a heading direction associated with the respective vehicle of the set of vehicles,
a vehicle type associated with the respective vehicle of the set of vehicles,
a set of global navigation satellite system (GNSS) coordinates associated with the respective vehicle of the set of vehicles,
a vehicle identifier (ID) associated with the respective vehicle of the set of vehicles,
a destination address associated with the respective vehicle of the set of vehicles,
a fuel or battery status associated with the respective vehicle of the set of vehicles, or
a trust level associated with the respective vehicle of the set of vehicles.

5. The apparatus of claim 2, wherein to identify the set of non-malicious vehicles based on the kinematics data, the at least one processor, individually or in any combination, is configured to:
verify the kinematics data associated with a subset of vehicles of the set of vehicles based on at least one camera, at least one light detection and ranging (Lidar) sensor, at least one radio detection and ranging (radar) sensor, or at least one vehicle to everything (V2X) sensor associated with the first vehicle, wherein the subset of vehicles is within a line of sight (LoS) of the first vehicle.

6. The apparatus of claim 5, wherein to verify the kinematics data associated with the subset of vehicles, the at least one processor, individually or in any combination, is configured to:
store the kinematics data;
generate second kinematics data associated with the subset of vehicles for a second period of time based on the at least one camera, the at least one Lidar sensor, the at least one radar sensor, or the at least one V2X sensor; and
compare the kinematics data with the second kinematics data to verify the kinematics data associated with the subset of vehicles in an overlapping portion of the period of time and the second period of time.

7. The apparatus of claim 1, wherein to identify the set of non-malicious vehicles, the at least one processor, individually or in any combination, is configured to:
receive the communication from the RSU, wherein the communication comprises a request to configure the platoon and at least one of: an identifier (ID) associated with the RSU, a set of global navigation satellite system (GNSS) coordinates associated with the RSU, a set of positioning related signaling parameters, or a set of cryptographic certificates associated with the RSU or the set of non-malicious vehicles.

8. The apparatus of claim 1, wherein the at least one processor, individually or in any combination, is further configured to:
receive, from the RSU, information regarding at least one of: a platoon leader associated with the platoon, a platoon formation lane associated with the platoon, an average speed associated with the platoon, an inter-vehicle distance associated with the platoon, or a platoon identifier (ID) associated with the platoon.

9. The apparatus of claim 1, wherein the request message is a maneuver sharing and coordination message (MSCM) request comprising information regarding at least one of: a platoon leader associated with the platoon, a platoon formation lane associated with the platoon, an average speed associated with the platoon, an inter-vehicle distance associated with the platoon, or a platoon identifier (ID) associated with the platoon, and wherein the acceptance message is a MSCM response.

10. The apparatus of claim 9, wherein to configure the platoon, the at least one processor, individually or in any combination, is configured to:
move the first vehicle to a position on the platoon formation lane; and
configure a communication key for the platoon with the at least one vehicle.

11. The apparatus of claim 9, wherein to configure the platoon, the at least one processor, individually or in any combination, is configured to:
receive, from the at least one vehicle, an approximate destination and a proposal regarding the platoon leader; and
transmit a vote for the platoon leader to the at least one vehicle.

12. The apparatus of claim 1, wherein the at least one processor, individually or in any combination, is further configured to:
identify a second set of non-malicious vehicles;
communicate, with the at least one vehicle, trust information regarding the second set of non-malicious vehicles;
communicate, with the at least one vehicle, whether to invite the second set of non-malicious vehicles to the platoon; and
transmit a second request message to the second set of non-malicious vehicles or refrain from transmitting the second request message to the second set of non-malicious vehicles based on whether to invite the second set of non-malicious vehicles to the platoon.

13. The apparatus of claim 1, wherein the at least one processor, individually or in any combination, is further configured to:
receive, from at least one other vehicle of the set of non-malicious vehicles, a denial message indicating a lack of joining the platoon.

14. The apparatus of claim 1, wherein the at least one processor, individually or in any combination, is further configured to:
receive, from a third vehicle, a second request message to join the platoon;
identify whether the third vehicle is malicious;
communicate, with the at least one vehicle, whether to invite the second set of non-malicious vehicles to the platoon based on the identification of whether the third vehicle is malicious; and
transmit a second response message to the third vehicle to allow the third vehicle to join the platoon or refrain from transmitting the second response message to the third vehicle based on the communication of whether to invite the third vehicle to the platoon.

15. The apparatus of claim 14, wherein the second response message comprises a position in the platoon associated with the third vehicle and a speed associated with the platoon.

16. The apparatus of claim 15, wherein the at least one processor, individually or in any combination, is further configured to:
register a cryptographic certificate associated with the third vehicle; and
configure an updated communication key for the platoon with the at least one vehicle and the third vehicle.

17. The apparatus of claim 1, wherein the at least one processor, individually or in any combination, is further configured to:
receive, from one particular vehicle in the platoon, a second request message to depart from the platoon;
transmit, to one or more other vehicles in the platoon, a third request message comprising information regarding the second request message to depart from the platoon; and
receive, from each of the one or more other vehicles in the platoon, a second response message indicating agreement or disagreement with the second request message to depart from the platoon.

18. The apparatus of claim 17, wherein the second request message is a maneuver sharing and coordination message (MSCM) request, wherein the third request message is a second MSCM request, and wherein the second response message is a MSCM response.

19. The apparatus of claim 17, wherein the second response from each of the one or more other vehicles in the platoon indicates agreement with the second request message to depart from the platoon, and wherein the at least one processor, individually or in any combination, is further configured to:
move the first vehicle based on a departure of the one particular vehicle.

20. The apparatus of claim 17, wherein the second response from each of the one or more other vehicles in the platoon indicates agreement, and wherein the at least one processor, individually or in any combination, is further configured to:
deregister a cryptographic certificate associated with the one particular vehicle; and
configure an updated communication key for the platoon without the one particular vehicle.

21. The apparatus of claim 1, wherein the at least one processor, individually or in any combination, is further configured to:
communicate, with the at least one vehicle, kinematics data regarding the at least one vehicle and the first vehicle to identify malicious behavior associated with the at least one vehicle or the first vehicle; and
communicate, with the at least one vehicle, whether to remove a particular vehicle from the platoon based on the particular vehicle being associated with the malicious behavior.

22. The apparatus of claim 21, wherein the communication of whether to remove the particular vehicle from the platoon based on the particular vehicle being associated with the malicious behavior is based on the kinematics data associated with the particular vehicle compared with a standard deviation associated with the kinematics data regarding the at least one vehicle and the first vehicle.

23. The apparatus of claim 1, wherein to configure the platoon, the at least one processor, individually or in any combination, is configured to:
register a cryptographic certificate associated with the at least one vehicle; and
configure a communication key for the platoon.

24. The apparatus of claim 1, further comprising at least one of a transceiver or an antenna coupled to the at least one processor, wherein to transmit the request message, the at least one processor, individually or in any combination, is configured to: transmit the request message via at least one of the transceiver or the antenna.

25. A method for platoon formation performed by a first vehicle, comprising:
identifying a set of non-malicious vehicles based on at least one of data associated with the set of non-malicious vehicles or communication from a second vehicle or a road side unit (RSU);
transmitting a request message to the set of non-malicious vehicles;
receiving an acceptance message from at least one vehicle of the set of non-malicious vehicles; and
configuring a platoon with the at least one vehicle of the set of non-malicious vehicles.

26. The method of claim 25, wherein identifying the set of non-malicious vehicles further comprises:
monitoring kinematics data associated with a set of vehicles including the set of non-malicious vehicles, wherein the kinematics data is associated with the set of vehicles for a period of time; and
identifying the set of non-malicious vehicles based on the kinematics data.

27. The method of claim 26, wherein monitoring the kinematics data further comprises:
monitoring the kinematics data based on a set of basic safety messages or a collective perception service, wherein the communication from the second vehicle or the RSU corresponds to a basic safety message of the set of basic safety messages or a message for the collective perception service.

28. The method of claim 26, wherein identifying the set of non-malicious vehicles based on the kinematics data further comprises:
verifying the kinematics data associated with a subset of vehicles of the set of vehicles based on at least one camera, at least one light detection and ranging (Lidar) sensor, at least one radio detection and ranging (radar) sensor, or at least one vehicle to everything (V2X) sensor associated with the first vehicle, wherein the subset of vehicles is within a line of sight (LoS) of the first vehicle.

29. An apparatus for platoon formation at a first vehicle, comprising:
means for identifying a set of non-malicious vehicles based on at least one of data associated with the set of non-malicious vehicles or communication from a second vehicle or a road side unit (RSU);
means for transmitting a request message to the set of non-malicious vehicles;
means for receiving an acceptance message from at least one vehicle of the set of non-malicious vehicles; and
means for configuring a platoon with the at least one vehicle of the set of non-malicious vehicles.

30. A computer-readable medium storing computer executable code, the code when executed by at least one processor causes the at least one processor to:
identify a set of non-malicious vehicles based on at least one of data associated with the set of non-malicious vehicles or communication from a second vehicle or a road side unit (RSU);
transmit a request message to the set of non-malicious vehicles;
receive an acceptance message from at least one vehicle of the set of non-malicious vehicles; and
configure a platoon with the at least one vehicle of the set of non-malicious vehicles.
